(19) United States
(12) Patent Application Publication
(10) Pub. No.: US 2026/0113708 A1
(43) Pub. Date: Apr. 23, 2026

(54) Communication Operation Execution Method and Terminal, and Non-Transitory Readable Storage Medium

(71) Applicant: VIVO MOBILE COMMUNICATION CO.,LTD., Dongguan (CN)

(72) Inventor: Li Chen, Dongguan (CN)

(21) Appl. No.: 19/252,516

(22) Filed: Jun. 27, 2025

Related U.S. Application Data
(63) Continuation of application No. PCT/CN2023/141551, filed on Dec. 25, 2023.

(30) Foreign Application Priority Data
Dec. 28, 2022 (CN) 202211701638.9

(51) Int. Cl. H04W 52/02; H04W 24/10; H04W 72/231; H04W 72/51

(52) U.S. Cl. CPC H04W 52/0235; H04W 24/10; H04W 72/231; H04W 72/51

(57) ABSTRACT

A communication operation execution method, which includes executing, by a terminal, a first operation under a preset condition, where the first operation includes at least one of the following; an operation associated with a low power wake-up signal (LP-WUS), turning on a main radio or a main radio module, or receiving a signal by the main radio or the main radio module.

### CROSS-REFERENCE TO RELATED APPLICATIONS

This application is a Bypass Continuation Application of International Patent Application No. PCT/CN2023/141551 filed Dec. 25, 2023, and claims priority to Chinese Patent Application No. 202211701638.9, filed Dec. 28, 2022, the disclosures of which are hereby incorporated by reference in their entireties.

### BACKGROUND OF THE INVENTION

### FIELD OF THE INVENTION

This application pertains to the field of communication technologies, and relates to a communication operation execution method and a terminal, and a non-transitory readable storage medium.

### DESCRIPTION OF RELATED ART

Some communication systems introduce a low power wake-up signal (LP-WUS) and a low power wake-up module (which is also referred to as a Low Power Wake-Up Receiver, LP-WUR). The LP-WUR is a module or a receiver associated with the LP-WUS. A terminal wakes up a main communication module/main radio by monitoring the LP-WUS, to save power.

### SUMMARY OF THE INVENTION

The embodiments of this application provide a communication operation execution method and a terminal, and a non-transitory readable storage medium.

According to a first aspect, a communication operation execution method is provided. The method includes:
executing, by a terminal, a first operation under a preset condition, where the first operation includes at least one of the following:
an operation associated with a low power wake-up signal LP-WUS;
turning on a main radio or a main radio module; or
receiving a signal by the main radio or the main radio module.

According to a second aspect, a communication operation execution apparatus is provided. The apparatus includes:
an execution module, configured to execute a first operation under a preset condition, where the first operation includes at least one of the following:
an operation associated with a low power wake-up signal LP-WUS;
turning on a main radio or a main radio module; or
receiving a signal by the main radio or the main radio module.

According to a third aspect, a terminal is provided. The terminal includes a processor and a memory, and the memory stores a program or an instruction that is executable on the processor; and when the program or the instruction is executed by the processor, the steps of the method according to the first aspect are implemented.

According to a fourth aspect, a terminal is provided. The terminal includes a processor and a communication interface. The processor is configured to:
execute a first operation under a preset condition, where the first operation includes at least one of the following:
an operation associated with a low power wake-up signal LP-WUS;
turning on a main radio or a main radio module; or
receiving a signal by the main radio or the main radio module.

According to a fifth aspect, a communication operation execution system is provided. The system includes: a terminal. The terminal may be configured to perform the steps of the communication operation execution method according to the first aspect.

According to a sixth aspect, a non-transitory readable storage medium is provided. The non-transitory readable storage medium stores a program or an instruction; and when the program or the instruction is executed by a processor, the steps of the method according to the first aspect are implemented.

According to a seventh aspect, a chip is provided. The chip includes a processor and a communication interface, the communication interface is coupled to the processor, and the processor is configured to execute a program or an instruction to implement the method according to the first aspect.

According to an eighth aspect, a computer program/program product is provided. The computer program/program product is stored in a storage medium, and the computer program/program product is executed by at least one processor to implement the steps of the method according to the first aspect.

### BRIEF DESCRIPTION OF THE DRAWINGS

FIG. 1 is a block diagram of a wireless communication system to which the embodiments of this application are applicable;

FIG. 2 is a schematic diagram of a structure of a terminal to which the embodiments of this application are applicable;

FIG. 3 is a schematic diagram of a structure of a signal to which the embodiments of this application are applicable;

FIG. 4 is a schematic diagram of a structure of a low power wake-up receiver according to a related technology;

FIG. 5 is a schematic diagram of a WUR beacon frame structure according to a related technology;

FIG. 6 is a schematic flowchart of a communication operation execution method according to an embodiment of this application;

FIG. 7 is a schematic flowchart of a communication operation execution apparatus according to an embodiment of this application;

FIG. 8 is a schematic diagram of a structure of a communication device according to an embodiment of this application; and

FIG. 9 is a schematic diagram of a hardware structure of a terminal according to an embodiment of this application.

### DESCRIPTION OF THE INVENTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in this specification and the claims, “and/or” represents at least one of connected objects, and a character “/” generally represents an “or” relationship between associated objects.

It should be noted that the technologies described in the embodiments of this application are not limited to a long term evolution (LTE)/LTE-advanced (LTE-A) system, and may also be used in other wireless communication systems such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, and another system. The terms “system” and “network” in the embodiments of this application may be used interchangeably. The technologies described can be applied to both the systems and the radio technologies mentioned above as well as to other systems and radio technologies. A new radio (NR) system is described in the following descriptions for illustrative purposes, and the NR terminology is used in most of the following descriptions, although these technologies can also be applied to applications other than the NR system application, such as a 6^{th} generation (6G) communication system.

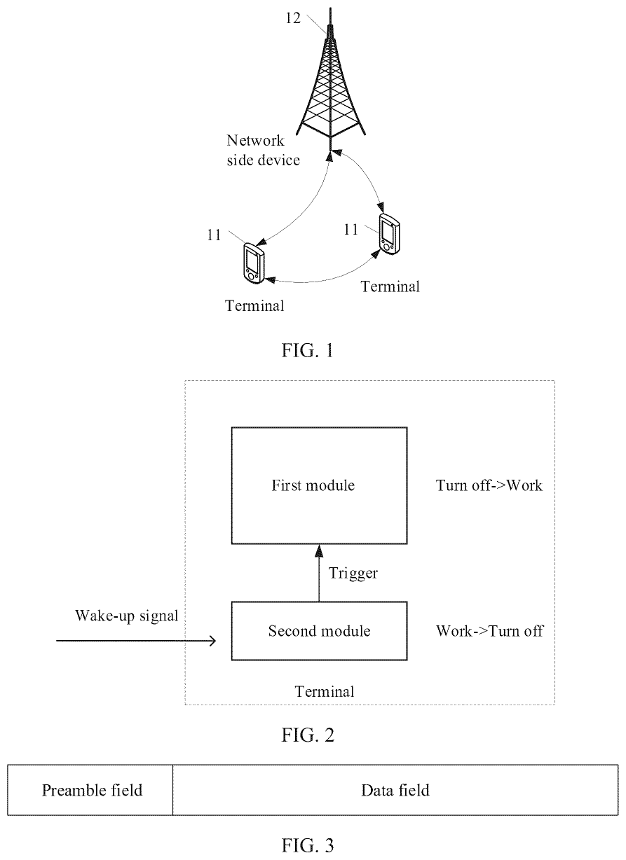

FIG. 1 is a block diagram of a wireless communication system to which the embodiments of this application are applicable. The wireless communication system includes a terminal 11 and a network side 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. It should be noted that a specific type of the terminal 11 is not limited in the embodiments of this application. The network side 12 may include an access network device or a core network device. The access network device may also be referred to as a radio access network device, a radio access network (RAN), a radio access network function, or a radio access network unit. The access network device may include a base station, a WLAN access point, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another appropriate term in the field. Provided that same technical effect is achieved, the base station is not limited to a specified technical term. It should be noted that in the embodiments of this application, only a base station in an NR system is used as an example for description, and a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function unit (PCRF), an edge application server discovery function (EASDF), a unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that, in the embodiments of this application, only a core network device in an NR system is used as an example for description, and a specific type of the core network device is not limited.

The following content is first described.

An LP-WUS may be received by an LP WUR, and is used to wake up a main communication module and the like. FIG. 2 is a schematic diagram of a structure of a terminal to which the embodiments of this application are applicable. As shown in FIG. 2, the terminal includes two modules. A first module is a main communication module, configured to receive and send mobile communication data, and a second module is a low power wake-up receiving module, configured to receive a low power wake-up signal and a low power beacon signal that are sent by a transmit end. The low power wake-up signal may be used to wake up the main communication module of a receive end, and the low power beacon signal may be used to provide time reference information and other information for receiving the low power wake-up signal, and may also provide wake-up link management.

As shown in FIG. 2, when the first module is not waked up by the second module, the first module is always in an off state, and does not send and receive data. When downlink data arrives, the second module detects a wake-up signal sent by the transmit end, and the wake-up signal includes information about the terminal, the second module triggers the first module to switch from the off state to a working state, to receive and send data. The second module may be continuously turned on, or discontinuously turned on. When the second module is turned on, the second module may receive the low power wake-up signal and the low power beacon signal.

However, because a function of an LP-WUR receiving module is simple and costs are low, receiving performance is poor. For example, sensitivity is poor. In a scenario in which the terminal needs to have high receiving performance, for example, the terminal is located at a cell edge, mobility of the terminal and delay performance of a service are poor.

In some embodiments, FIG. 3 is a schematic diagram of a structure of a signal to which the embodiments of this application are applicable. A basic framework of an LP-WUS may be shown in FIG. 3, and includes:
a preamble field and a data field.

A purpose of the preamble field includes but is not limited to at least one of detection, synchronization, or data rate determining of the LP-WUS. In addition, the preamble field may be further used to indicate a user identifier, a user group identifier, or the like. The data field may be used to carry a data part. In addition, the data field may further include at least one of the following:
a user identifier or a user group identifier, a bit for waking up a terminal, a bit that carries another function such as system information update, an emergency message, a random access channel (RACH), or operation correlation after the terminal is waken up, where the operation correlation after the terminal is waken up may be: whether a synchronization signal block (SSB) needs to be received, whether cell selection and reselection need to be performed, whether system information needs to be received, or the like.

In addition, the beacon signal is similar, and may also include a preamble and a data part.

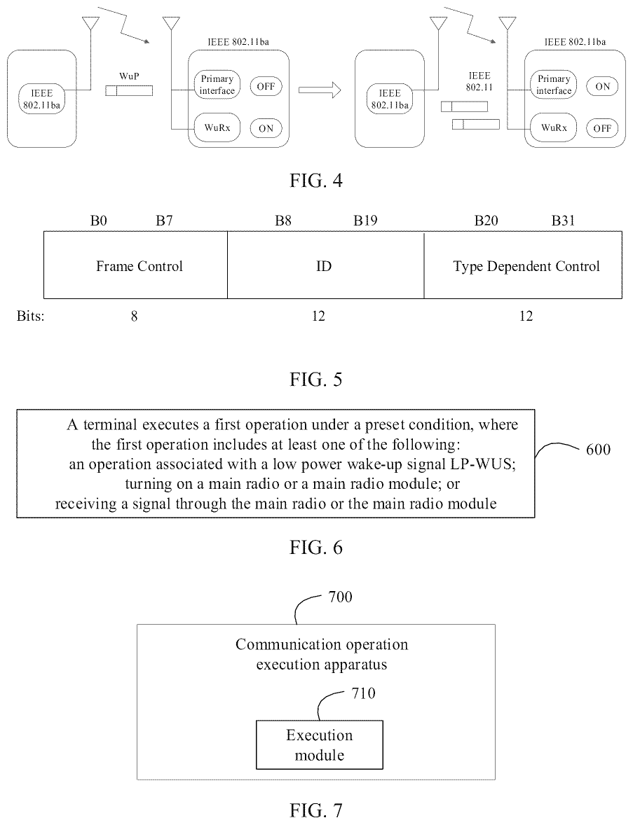

FIG. 4 is a schematic diagram of a structure of a low power wake-up receiver according to a related technology. As shown in FIG. 4, user equipment includes two parts: a primary interface and a wake-up receiver. The primary interface is configured to send and receive Wi-Fi data. The wake-up receiver is configured to wake up the primary interface. Before being waken up, the primary interface is in an off state, and does not send and receive the data. The wake-up receiver receives a wake-up signal sent by an AP, and the wake-up signal may be an OOK modulated signal, so that the wake-up receiver may detect the wake-up signal in an envelope detection manner, and power consumption can be reduced to hundreds of microwatts, thereby greatly reducing power consumption of the user equipment.

FIG. 5 is a schematic diagram of a WUR beacon frame structure according to a related technology. As shown in FIG. 5, to maintain synchronization between a low power wake-up receiver and an AP, a WUR beacon signal may be periodically sent to transfer time information. As shown in FIG. 5, a type dependent control of a WUR beacon MAC frame carries 12-bit information [5:16] in TSF timer 64 bits of the AP. After receiving the 12-bit information, a user updates a local TSF timer according to a time update rule, to achieve synchronization with the AP. A sending period of a WUR beacon and an offset of a sending start location are indicated by an operation element sent by the AP, the period is a minimum quantity of TSF time units between two times of beacon sending, and the start location is a quantity of TSF time units relative to an offset of a TSF 0. When CSMA deferrals occur, the WUR beacon is sent with a delay in the current period, but is still sent in a subsequent period based on the sending period of the WUR beacon and a location determined using the sending start location.

The following describes in detail a communication operation execution method and apparatus, and a terminal provided in the embodiments of this application by using some embodiments and application scenarios thereof with reference to the accompanying drawings.

FIG. 6 is a schematic flowchart of a communication operation execution method according to an embodiment of this application. As shown in FIG. 6, the method includes the following steps.

Step 600: A terminal executes a first operation under a preset condition, where the first operation includes at least one of the following:
an operation associated with a low power wake-up signal LP-WUS;
turning on a main radio or a main radio module; or
receiving a signal by the main radio or the main radio module.

Optionally, in a scenario in which the terminal needs to have high receiving performance, for example, the terminal is located at a cell edge, to improve mobility and reachability of the terminal, and improve communication quality, the terminal may execute the first operation under the preset condition, so that the terminal can execute the operation associated with the low power wake-up signal LP-WUS, turn on the main radio or the main radio module, and receive the signal by the main radio or the main radio module; exit from LP-Sleep or fall back to a normal state; and can normally monitor a physical downlink control channel (PDCCH), to effectively ensure mobile performance of the terminal and delay performance of a service.

Optionally, to improve mobility and reachability of the terminal, and improve communication quality, the terminal may execute the first operation under the preset condition, so that the terminal can execute the operation associated with the low power wake-up signal LP-WUS, turn on the main radio or the main radio module, and receive the signal by the main radio or the main radio module; fall back to a normal state; and can normally monitor a physical downlink control channel (PDCCH), to effectively ensure mobile performance of the terminal and delay performance of a service.

Optionally, the PDCCH may be a PDCCH corresponding to a paging message or a PDCCH corresponding to another message.

Optionally, a scenario in which the terminal uses an LP-WUS function may be limited by using the preset condition, so that mobile performance and communication quality of the terminal can be effectively ensured in a case that the terminal with a high receiving performance requirement is ensured.

Optionally, the preset condition may be a preset condition associated with at least one of cell measurement performance, a moving state, a receiving state, a terminal type, or a terminal capability. For example, the cell measurement performance is lower than or not higher than a preset threshold, the mobility state indicates that the terminal is in high mobility, the terminal receives preset information, the terminal type is a high-capability terminal, and the terminal capability supports a fallback mechanism.

Optionally, the preset condition may include all conditions that may be used to trigger the terminal to fall back to the normal state, or trigger the terminal to exit LP-Sleep, or represent that the terminal may fall back to the normal state, or represent that the terminal may exit LP-Sleep. This is not limited in this embodiment of this application.

Optionally, executing the operation associated with the low power wake-up signal LP-WUS may include executing an operation, used for fallback, associated with the LP-WUS.

Optionally, the main radio module may be a main communication module.

Optionally, turning on the main radio or the main radio module or receiving the signal by the main radio or the main radio module may include at least one of the following:
monitoring the physical downlink control channel (PDCCH) by the main radio or the main radio module; or
receiving the LP-WUS by the main radio or the main radio module.

In this embodiment of this application, the terminal executes the first operation under the preset condition, where the first operation includes at least one of the following: the operation associated with the low power wake-up signal LP-WUS; turning on the main radio or the main radio module; or receiving the signal by the main radio or the main radio module. In this way, fallback to the normal state may be performed when the preset condition is satisfied; and the scenario in which the terminal uses the LP-WUS function is limited, so that fast and accurate fallback can be performed when it is ensured that the terminal saves power as much as possible, thereby effectively ensuring mobile performance of the terminal and delay performance of the service.

Optionally, the operation associated with the low power wake-up signal LP-WUS includes at least one of the following:
skipping or ignoring the low power wake-up signal LP-WUS;
turning off a low power wake-up receiver or a low power wake-up receiving module LP-WUR;
deactivating or disabling a low power wake-up function; or
exiting a low power sleep state.

Optionally, monitoring the LP-WUS may be that the physical downlink control channel (PDCCH) is not monitored, and the LP-WUS is monitored; and when the LP-WUS is monitored, the main communication module or the main radio is in an off state, a non-working state, or an inactive state.

Optionally, turning off the LP-WUR indicates turning off the LP-WUR or deactivating the LP-WUR.

Optionally, turning off the LP-WUR indicates not monitoring or receiving the signal by the LP-WUR, and monitoring the PDCCH.

Optionally, deactivating or disabling the low power wake-up function indicates not monitoring the LP-WUS, and monitoring the PDCCH.

Optionally, when the terminal is in the low power sleep state, the terminal may monitor the LP-WUS. When the terminal exits the low power sleep state, the terminal may stop monitoring the LP-WUS, and monitor the PDCCH.

In this embodiment of this application, at least one of skipping or ignoring the low power wake-up signal LP-WUS, turning off the low power wake-up receiver or the low power wake-up receiving module LP-WUR, deactivating or disabling the low power wake-up function, or exiting the low power sleep state may be performed, so that the LP-WUS is not monitored, and the PDCCH is normally monitored, thereby improving mobility and timeliness for receiving the signal, and improving communication quality.

Optionally, the skipping or ignoring the low power wake-up signal LP-WUS includes:
temporarily skipping or ignoring the low power wake-up signal LP-WUS.

Optionally, the skipping or ignoring the low power wake-up signal LP-WUS includes at least one of the following:
(1) temporarily skipping or ignoring the low power wake-up signal LP-WUS; or
(2) temporarily skipping or ignoring (Skip) the low power wake-up signal LP-WUS until a next time of turning on.

Optionally, temporarily skipping or ignoring the low power wake-up signal LP-WUS may indicate that time for skipping or ignoring the low power wake-up signal LP-WUS is short.

Optionally, temporarily skipping or ignoring the low power wake-up signal LP-WUS may indicate that time for skipping or ignoring the low power wake-up signal LP-WUS is not permanent or is not necessarily permanent.

In this embodiment of this application, the low power wake-up signal LP-WUS is temporarily skipped or neglected, so that when there is a fallback requirement, the terminal temporarily falls back to the normal state, thereby improving flexibility of applying the LP-WUS function by the terminal; and communication quality can also be improved in a case that energy saving of the terminal is ensured.

Optionally, the temporarily skipping or ignoring (Skip) the low power wake-up signal LP-WUS includes at least one of the following:
skipping or ignoring a current or next LP-WUS;
skipping or ignoring the low power wake-up signal LP-WUS, where a quantity of skipped or ignored LP-WUSs is a fifth preset quantity;
skipping or ignoring the low power wake-up signal LP-WUS, where duration of the skipped or ignored LP-WUS is a first preset quantity of periods;
skipping or ignoring the low power wake-up signal LP-WUS, where time for skipping or ignoring the LP-WUS is a first preset time period; or
skipping or ignoring the low power wake-up signal LP-WUS until monitoring of the LP-WUS is enabled, or until the low power wake-up function is enabled or activated, or until the LP-WUR is turned on.

Optionally, the temporarily skipping or ignoring (Skip) the low power wake-up signal LP-WUS includes at least one of the following:
(a) skipping or ignoring a current LP-WUS;
(b) skipping or ignoring a fifth preset quantity of LP-WUSs;
(c) skipping or ignoring an LP-WUS of a first preset quantity of periods; or
(d) skipping or ignoring an LP-WUS in a first preset time period.

Optionally, the first preset quantity is predefined, preconfigured, indicated by a network side, or preset.

Optionally, the fifth preset quantity is predefined, preconfigured, indicated by the network side, or preset.

Optionally, the first preset time period is predefined, preconfigured, indicated by a network side, or preset.

Optionally, the low power wake-up signal LP-WUS is skipped or ignored until monitoring of the LP-WUS is enabled.

Optionally, the low power wake-up signal LP-WUS is skipped or ignored until the low power wake-up function is enabled or activated.

Optionally, the low power wake-up signal LP-WUS is skipped or ignored until the LP-WUR is turned on.

Optionally, the period is a period of a low power signal, or a period of a beacon signal, or a period of monitoring the low power signal, or a period of monitoring the beacon signal.

In this embodiment of this application, a preset quantity of LP-WUSs or an LP-WUS in preset time is skipped, so that the terminal temporarily falls back to the normal state in the corresponding time, thereby improving flexibility of applying the LP-WUS function by the terminal; implementation is simple; and communication quality can also be improved in a case that energy saving of the terminal is ensured.

Optionally, the skipping or ignoring the low power wake-up signal LP-WUS until monitoring of the LP-WUS is enabled, or until the low power wake-up function is enabled or activated, or until the LP-WUR is turned on includes at least one of the following:
skipping or ignoring the low power wake-up signal LP-WUS until a network side indicates the terminal to monitor the LP-WUS;
skipping or ignoring the low power wake-up signal LP-WUS until the network side indicates the terminal to enable or activate the low power wake-up function;
skipping or ignoring the low power wake-up signal LP-WUS until the network side indicates the terminal to turn on the LP-WUR;
skipping or ignoring the low power wake-up signal LP-WUS until monitoring of the LP-WUS is enabled, the low power wake-up function is enabled or activated, or a preset condition corresponding to the LP-WUR is enabled; or
skipping or ignoring the low power wake-up signal LP-WUS until the network side configures the LP-WUS or the LP-WUR.

Optionally, the low power wake-up signal LP-WUS is temporarily skipped or ignored (Skip) until the next time of turning on, where the next time of turning on includes at least one of the following:
(a) the network side indicates the terminal to monitor the LP-WUS;
(b) the network side indicates the terminal to turn on the LP-WUR;
(c) when a second preset condition is satisfied, monitoring of the LP-WUS is enabled; or
(d) the network side configures the LP-WUS or the LP-WUR.

In this embodiment of this application, the low power wake-up signal LP-WUS is skipped or ignored until monitoring of the LP-WUS is enabled, or until the low power wake-up function is enabled or activated, or until the LP-WUR is turned on, so that not only receiving performance of the terminal can be improved when the terminal has high receiving performance, but also the LP-WUS function can be enabled in a timely manner, thereby effectively saving energy, and improving communication flexibility of the terminal.

Optionally, the turning off a low power wake-up receiver or a low power wake-up receiving module LP-WUR, or deactivating or disabling a low power wake-up function includes:
temporarily turning off the low power wake-up receiver or the low power wake-up receiving module LP-WUR, or temporarily deactivating or disabling the low power wake-up function.

Optionally, the turning off the low power wake-up receiver or the low power wake-up receiving module LP-WUR (LP-WUS disable) includes at least one of the following:
1. temporarily deactivating or disabling the LP-WUS function; or
2. deactivating or disabling the LP-WUS function until the next time of turning on.

In this embodiment of this application, the low power wake-up receiver or the low power wake-up receiving module LP-WUR is temporarily turned off, or the low power wake-up function is temporarily deactivated or disabled, so that when there is a fallback requirement, the terminal temporarily falls back to the normal state, thereby improving flexibility of applying the LP-WUS function by the terminal; and communication quality can also be improved in a case that energy saving of the terminal is ensured.

Optionally, the temporarily turning off the low power wake-up receiver or the low power wake-up receiving module LP-WUR, or temporarily deactivating or disabling the low power wake-up function includes at least one of the following:
turning off the LP-WUR for a current or next LP-WUS;
turning off the LP-WUR, where duration of turning off the LP-WUR is a second preset quantity of periods;
turning off the LP-WUR, where duration of turning off the LP-WUR is a second preset time period;
turning off the LP-WUR until monitoring of the LP-WUS is enabled, or until the low power wake-up function is enabled or activated, or until the LP-WUR is turned on;
deactivating or disabling the low power wake-up function, where duration of deactivating or disabling the low power wake-up function is a second preset quantity of periods;
deactivating or disabling the low power wake-up function, where duration of deactivating or disabling the low power wake-up function is a second preset time period; or
deactivating or disabling the low power wake-up function until monitoring of the LP-WUS is enabled, or until the low power wake-up function is enabled or activated, or until the LP-WUR is turned on.

Optionally, the temporarily deactivating or disabling the LP-WUS function includes at least one of the following:
(a) deactivating or disabling monitoring of the LP-WUS, or deactivating or turning off the LP-WUR in the second preset time period; or
(b) deactivating or disabling monitoring of the LP-WUS, or deactivating or turning off the LP-WUR in the second preset quantity of periods.

Optionally, the second preset time period is predefined, preconfigured, indicated by the network side, or preset.

Optionally, the second preset quantity is predefined, preconfigured, indicated by the network side, or preset.

In this embodiment of this application, monitoring of a preset quantity of LP-WUSs is deactivated or disabled or a preset quantity of LP-WURs is deactivated or turned off, or monitoring of the LP-WUS in preset time is deactivated or disabled or the LP-WUR in preset time is deactivated or turned off, so that the terminal temporarily falls back to the normal state in the corresponding time, thereby improving flexibility of applying the LP-WUS function by the terminal; implementation is simple; and communication quality can also be improved in a case that energy saving of the terminal is ensured.

Optionally, the turning off the LP-WUR, or deactivating or disabling the low power wake-up function until monitoring of the LP-WUS is enabled, or until the low power wake-up function is enabled or activated, or until the LP-WUR is turned on includes at least one of the following:
turning off the LP-WUR, or deactivating or disabling the low power wake-up function until a network side indicates the terminal to monitor the LP-WUS;
turning off the LP-WUR, or deactivating or disabling the low power wake-up function until the network side indicates the terminal to enable or activate the low power wake-up function;
turning off the LP-WUR, or deactivating or disabling the low power wake-up function until the network side indicates the terminal to turn on the LP-WUR;
turning off the LP-WUR, or deactivating or disabling the low power wake-up function until monitoring of the LP-WUS is enabled, the low power wake-up function is enabled or activated, or a preset condition corresponding to the LP-WUR is enabled; or
turning off the LP-WUR, or deactivating or disabling the low power wake-up function until the network side configures the LP-WUS or the LP-WUR.

Optionally, the LP-WUS function is temporarily deactivated or disabled until the next time of turning on, where the next time of turning on includes at least one of the following:
(a) the network side indicates the terminal to monitor the LP-WUS;
(b) the network side indicates the terminal to turn on the LP-WUR;
(c) when a second preset condition is satisfied, monitoring of the LP-WUS or the LP-WUR is activated or turned on; or
(d) the network side configures the LP-WUS or the LP-WUR.

In this embodiment of this application, the LP-WUR is turned off or the low power wake-up function is deactivated or disabled until monitoring of the LP-WUS is enabled, or until the low power wake-up function is enabled or activated, or until the LP-WUR is turned on, so that not only receiving performance of the terminal can be improved when the terminal has high receiving performance, but also the LP-WUS function can be enabled in a timely manner, thereby effectively saving energy, and improving communication flexibility of the terminal.

Optionally, the receiving the signal by the main radio or the main radio module includes:
monitoring a physical downlink control channel by the main radio or the main radio module; and
receiving the low power wake-up signal by the main radio or the main radio module.

Optionally, the receiving the signal by the main radio or the main radio module (Main receiver) includes at least one of the following:
monitoring the PDCCH by the main receiver;
monitoring the PDCCH by the main receiver after preset time;
receiving the LP-WUS by the main receiver; or
receiving the LP-WUS by the main receiver after the preset time.

Optionally, the PDCCH may be a PDCCH corresponding to a paging message or a PDCCH corresponding to another message or channel.

In this embodiment of this application, the main radio or the main radio module monitors the physical downlink control channel and/or receives the low power wake-up signal, so that timeliness for receiving a downlink signal can be improved, and communication quality of the terminal is improved.

Optionally, the preset condition includes at least one of the following:
satisfying a first preset condition or not satisfying the second preset condition, where
the first preset condition includes a condition associated with at least one of the following:
cell measurement performance, a moving state, a receiving state, a terminal type, or a terminal capability; and/or
the second preset condition includes a condition associated with at least one of the following:
cell measurement performance, a moving state, a receiving state, a terminal type, or a terminal capability.

Optionally, the first preset condition and the second preset condition may be configured by the network side or protocol-agreed.

Optionally, limitations of the first preset condition and the second preset condition are used, so that the receiving performance of the terminal can be improved.

Optionally, the preset conditions can effectively limit use scenarios of LP-WUS, so that the terminal can fall back to the normal state or exit the sleep state in a case that a high-performance requirement is received, to ensure fast accessibility and mobility of the terminal.

In this embodiment of this application, a condition related to the cell measurement performance, the moving state, the receiving state, the terminal type, and the terminal capability is limited to control whether to execute the first operation, so that a requirement of a better communication service can be satisfied.

Optionally, the first preset condition includes at least one of the following:
measurement performance of a serving cell satisfies a first performance condition;
measurement performance of a neighboring cell satisfies a second performance condition;
the terminal is not in low mobility;
the terminal is in high mobility;
the terminal receives first indication information sent by the network side, where the first indication information is used to indicate a fallback operation;
the terminal type of the terminal is a normal terminal;
the terminal type of the terminal is not a low-capability terminal; or
the terminal has a first capability.

Optionally, that the measurement performance of the serving cell satisfies the first performance condition may be understood as that a communication condition of the serving cell is poor. For example, the measurement performance is poorer than that of the neighboring cell. In this way, the foregoing operation can be executed in a case that the measurement performance of the serving cell is poorer than that of the neighboring cell, to improve the communication performance of the terminal.

Optionally, that the measurement performance of the neighboring cell satisfies the second performance condition may be understood as that a communication condition of the neighboring cell is good. For example, the measurement performance is better than that of the serving cell. In this way, the foregoing operation can be executed in a case that the measurement performance of the serving cell is poorer than that of the neighboring cell, to improve the communication performance of the terminal.

Optionally, a moving speed of the low mobility is lower than a moving speed of the high mobility. In this way, the foregoing operation can be executed in a case that the terminal is in the high mobility, to improve communication performance of the terminal; or the foregoing operation is not executed in a case of the low mobility, to avoid excessive energy consumption of the terminal because the foregoing operation is executed in a case that the terminal is in the low mobility.

Optionally, that the measurement performance of the serving cell satisfies the first performance condition includes:
the measurement performance of the serving cell of the terminal is lower than or not higher than a first preset threshold; and/or
that the measurement performance of the neighboring cell satisfies the second performance condition includes:
the measurement performance of the serving cell of the terminal is higher than or not lower than a second preset threshold.

Optionally, the first preset threshold is predefined, preconfigured, indicated by the network side, or preset.

Optionally, the second preset threshold is predefined, preconfigured, indicated by the network side, or preset.

Optionally, that the measurement performance of the serving cell of the terminal is lower than or not higher than a first preset threshold includes at least one of the following:
the measurement performance of the serving cell in a third preset time period is lower than or not higher than the first preset threshold;
the measurement performance of the serving cell remains lower than or not higher than the first preset threshold for a fourth preset time period;
the measurement performance of the serving cell is lower than or not higher than the first preset threshold for a first preset quantity of times; or
the measurement performance of the serving cell in a measurement period of a first preset quantity is lower than or not higher than the first preset threshold.

Optionally, the fourth preset time period is predefined, preconfigured, indicated by the network side, or preset.

Optionally, the third preset time period is predefined, preconfigured, indicated by the network side, or preset.

Optionally, the first preset quantity of times is predefined, preconfigured, indicated by the network side, or preset.

Optionally, the first preset quantity is predefined, preconfigured, indicated by a network side, or preset.

Optionally, the measurement period is a period of measurement sampling, a period of a measurement reference signal, or a period of a reference signal. The period of measurement sampling includes a period of sampling of L1 or L2 or L3 measurement.

Optionally, that the measurement performance of the neighboring cell of the terminal is higher than or not lower than a second preset threshold includes at least one of the following:
the measurement performance of the neighboring cell in a fifth preset time period is higher than or not lower than the second preset threshold;
the measurement performance of the neighboring cell remains higher than or not lower than the second preset threshold for a sixth preset time period;
the measurement performance of the neighboring cell is higher than or not lower than the second preset threshold for a second preset quantity of times; or
the measurement performance of the neighboring cell in a measurement period of a second preset quantity is higher than or not lower than the second preset threshold.

Optionally, the fifth preset time period is predefined, preconfigured, indicated by the network side, or preset.

Optionally, the sixth preset time period is predefined, preconfigured, indicated by the network side, or preset.

Optionally, the second preset quantity of times is predefined, preconfigured, indicated by the network side, or preset.

Optionally, the second preset quantity is predefined, preconfigured, indicated by the network side, or preset.

Optionally, the first preset condition includes at least one of the following:
(1) The measurement performance of the serving cell of the terminal is lower than or not higher than a first preset threshold.

Optionally, that the measurement performance of the serving cell of the terminal is lower than or not higher than a first preset threshold includes at least one of the following:
(a) in the third preset time period, being lower than or not higher than the first preset threshold;
(b) remaining lower than or not higher than the first preset threshold for the fourth preset time period;
(c) the measurement performance is lower than or not higher than the first preset threshold for the first preset quantity of times; or
(d) the measurement performance in the measurement period of the first preset quantity is lower than or not higher than the first preset threshold.
(2) The measurement performance of the neighboring cell of the terminal is higher than or not lower than the second preset threshold.

Optionally, that the measurement performance of the neighboring cell of the terminal is higher than or not lower than a second preset threshold includes at least one of the following:
(a) in the fifth preset time period, being higher than or not lower than the second preset threshold;
(b) remaining higher than or not lower than the second preset threshold for the sixth preset time period;
(c) the measurement performance is higher than or not lower than the second preset threshold for the second preset quantity of times; or
(d) the measurement performance in the measurement period of the second preset quantity is higher than or not lower than the second preset threshold.
(3) The terminal is not in low mobility.
(4) The terminal is in high mobility.
(5) The terminal receives the first indication information from the network side.
(6) The terminal type is not a low-capability terminal.
(7) The terminal supports a first capability.

Optionally, the first preset condition may be configured by the network side or protocol-agreed.

Optionally, the second preset condition includes:
measurement performance of a serving cell satisfies a third performance condition;
measurement performance of a neighboring cell satisfies a fourth performance condition;
the terminal is not in high mobility;
the terminal is in low mobility;
the terminal does not receive first indication information sent by the network side, where the first indication information is used to indicate a fallback operation;
the terminal type of the terminal is a low-capability terminal;
the terminal type of the terminal is not a normal terminal; and
the terminal has a second capability.

Optionally, that the measurement performance of the serving cell satisfies the third performance condition may be understood as that a communication condition of the serving cell is good. For example, the measurement performance is better than that of the neighboring cell. In this way, the foregoing operation may not be executed in a case that the measurement performance of the serving cell is better than that of the neighboring cell, to improve the communication performance of the terminal.

Optionally, that the measurement performance of the neighboring cell satisfies the fourth performance condition may be understood as that a communication condition of the neighboring cell is poor. For example, the measurement performance is poorer than that of the serving cell. In this way, the foregoing operation may not be executed in a case that the measurement performance of the serving cell is better than that of the neighboring cell, to improve the communication performance of the terminal.

Optionally, a moving speed of the low mobility is lower than a moving speed of the high mobility. In this way, the foregoing operation can be executed in a case that the terminal is in the high mobility, to improve communication performance of the terminal; or the foregoing operation is not executed in a case of the low mobility, to avoid excessive energy consumption of the terminal because the foregoing operation is executed in a case that the terminal is in the low mobility.

Optionally, that the measurement performance of the serving cell satisfies the third performance condition includes:
the measurement performance of the serving cell of the terminal is higher than or not lower than a third preset threshold; and/or
that the measurement performance of the neighboring cell satisfies the fourth performance condition includes:
the measurement performance of the neighboring cell of the terminal is lower than or not higher than a fourth preset threshold.

Optionally, the third preset threshold is predefined, preconfigured, indicated by the network side, or preset.

Optionally, the fourth preset threshold is predefined, preconfigured, indicated by the network side, or preset.

Optionally, that the measurement performance of the serving cell of the terminal is higher than or not lower than a third preset threshold includes:
the measurement performance of the serving cell in a seventh preset time period is higher than or not lower than the third preset threshold;
the measurement performance of the serving cell remains higher than or not lower than the third preset threshold for an eighth preset time period;
the measurement performance of the serving cell is higher than or not lower than the third preset threshold for a third preset quantity of times; and
the measurement performance of the serving cell in a measurement period of a third preset quantity is higher than or not lower than the third preset threshold.

Optionally, the seventh preset time period is predefined, preconfigured, indicated by the network side, or preset.

Optionally, the eighth preset time period is predefined, preconfigured, indicated by the network side, or preset.

Optionally, the third preset quantity of times is predefined, preconfigured, indicated by the network side, or preset.

Optionally, the third preset quantity is predefined, preconfigured, indicated by the network side, or preset.

Optionally, that the measurement performance of the neighboring cell of the terminal is lower than or not higher than a fourth preset threshold includes:
the measurement performance of the neighboring cell in a ninth preset time period is lower than or not higher than the fourth preset threshold;
the measurement performance of the neighboring cell remains lower than or not higher than the fourth preset threshold for a tenth preset time period;
the measurement performance of the neighboring cell is lower than or not higher than the fourth preset threshold for a fourth preset quantity of times; and
the measurement performance of the neighboring cell in a measurement period of a fourth preset quantity is lower than or not higher than the fourth preset threshold.

Optionally, the ninth preset time period is predefined, preconfigured, indicated by the network side, or preset.

Optionally, the tenth preset time period is predefined, preconfigured, indicated by the network side, or preset.

Optionally, the fourth preset quantity of times is predefined, preconfigured, indicated by the network side, or preset.

Optionally, the fourth preset quantity is predefined, preconfigured, indicated by the network side, or preset.

Optionally, the second preset condition includes at least one of the following:
(1) The measurement performance of the serving cell of the terminal is higher than or not lower than the third preset threshold.

Optionally, that the measurement performance of the serving cell of the terminal is higher than or not lower than a third preset threshold includes at least one of the following:
(a) in the seventh preset time period, being higher than or not lower than the third preset threshold;
(b) remaining higher than or not lower than the third preset threshold for the eighth preset time period;
(c) the measurement performance is higher than or not lower than the third preset threshold for the third preset quantity of times; or
(d) the measurement performance in the measurement period of the third preset quantity is higher than or not lower than the third preset threshold.
(2) The measurement performance of the neighboring cell of the terminal is lower than or not higher than the fourth preset threshold.

Optionally that the measurement performance of the neighboring cell of the terminal is lower than or not higher than a fourth preset threshold includes at least one of the following:
(a) in the ninth preset time period, being lower than or not higher than the fourth preset threshold;
(b) remaining lower than or not higher than the fourth preset threshold for the tenth preset time period;
(c) the measurement performance is lower than or not higher than the fourth preset threshold for the fourth preset quantity of times; or
(d) the measurement performance in the measurement period of the fourth preset quantity is lower than or not higher than the fourth preset threshold.
(3) The terminal is in low mobility.
(4) The terminal is not in high mobility.
(5) The terminal does not receive the first indication information from the network side.
(6) The terminal type is a low-capability terminal.
(7) The terminal type is not a normal terminal.

Optionally, the second preset condition is configured by the network side or protocol-agreed.

In some implementations, the low-capability terminal includes at least one of the following: a reduced capability (RedCap) terminal; a narrow band IoT (NBIoT) terminal; a machine-type communication (MTC) terminal, namely, an internet of things terminal; a passive terminal, for example, a passive internet of things (Passive IoT) terminal; a Wi-Fi terminal; a sidelink terminal; or a device-to-device (D2D) terminal.

In some implementations, the normal terminal includes at least one of the following:
another type of terminal other than at least one of the foregoing low-capability terminal; or
a terminal in a cellular network such as 3G, 4G, 5G, 6G, or 7G.

Optionally, the first capability includes at least one of the following:
supporting a capability of the low power wake-up receiver or the low power wake-up receiving module;
supporting a capability of the low power wake-up signal;
supporting a capability of a fallback mechanism in the low power sleep state;
supporting the capability of the fallback mechanism in the low power sleep state under the preset condition; and
supporting a capability of RRM measurement of a serving cell and/or neighboring cell during monitoring of the low power wake-up signal.

Optionally, the first capability includes at least one of the following:
1. the terminal supports the LP-WUR;
2. the terminal supports the LP-WUS;
3. the terminal supports the fallback mechanism; or
4. the terminal supports RRM measurement of the serving cell and/or neighboring cell during monitoring of the LP-WUS.

Optionally, the supporting a capability of a fallback mechanism in the low power sleep state includes at least one of the following:
supporting a capability of skipping or ignoring the low power wake-up signal;
supporting a capability of turning off the low power wake-up receiver or the low power wake-up receiving module;
supporting a capability of deactivating or disabling the low power wake-up function;
supporting a capability of turning on the main radio or the main radio module;
supporting a capability of monitoring the physical downlink control channel by the main radio or the main radio module; or
supporting a capability of receiving the low power wake-up signal by the main radio or the main radio module.

Optionally, the fallback mechanism may mean that the terminal may support a capability corresponding to at least one of the following, or the terminal may support a capability corresponding to at least one of the following under the preset condition:
(a) skipping or ignoring the LP-WUS (Skip LP-WUS);
(b) turning off the LP-WUR receiver/receiving module;
(c) deactivating or disabling the LP-WUS function (LP-WUS disable);
(d) turning on the main receiver;
(e) monitoring the PDCCH by the main receiver; or
(f) receiving the LP-WUS by the main receiver.

Optionally, the fallback mechanism may include determining the preset condition and/or executing the first operation in the present application.

Optionally, the second capability includes at least one of the following:
in a case that the first preset condition is not satisfied, supporting a capability of the low power wake-up receiver or the low power wake-up receiving module; or
in a case that the first preset condition is not satisfied, supporting a capability of monitoring the low power wake-up signal.

Optionally, the second capability includes at least one of the following:
(1) in a case that the first preset condition is not satisfied, the terminal supports a capability of the LP-WUR; or
(2) in a case that the first preset condition is not satisfied, the terminal supports a capability of monitoring the LP-WUS.

Optionally, the first indication information is used to indicate at least one of the following:
skipping or ignoring the low power wake-up signal;
turning off the low power wake-up receiver or the low power wake-up receiving module;
deactivating or disabling the low power wake-up function;
turning on the main radio or the main radio module;
monitoring the physical downlink control channel by the main radio or the main radio module; or
receiving the low power wake-up signal by the main radio or the main radio module.

Optionally, the first indication information satisfies at least one of the following:
1. indicating the terminal to skip or ignore the LP-WUS (Skip LP-WUS);
2. indicating the terminal to turn off the LP-WUR receiver/receiving module;
3. indicating the terminal to deactivate or disable the LP-WUS function (LP-WUS disable);
4. indicating the terminal to turn on the main receiver;
5. indicating the terminal to monitor the PDCCH by the main receiver; or
6. indicating the terminal to receive the LP-WUS by the main receiver.

Optionally, the first indication information may explicitly indicate to execute the operation associated with the LP-WUS, or the first indication information explicitly indicates the terminal to perform, based on the preset condition, one or more of the following operations: skipping or ignoring the low power wake-up signal, turning off the low power wake-up receiver or the low power wake-up receiving module, deactivating or disabling the low power wake-up function, turning on the main radio or the main radio module, monitoring the physical downlink control channel by the main radio or the main radio module, and receiving the low power wake-up signal by the main radio or the main radio module.

Optionally, the first indication information may implicitly indicate to execute the operation associated with the LP-WUS.

Optionally, the low mobility includes at least one of the following:
a measurement performance change amount is less than a fifth preset threshold;
a difference between measurement performance and a reference quantity is less than a sixth preset threshold;
a quantity of mobile cells is less than a seventh preset threshold;
a quantity of parameter change times is less than an eighth preset threshold; or
a moving speed is less than a ninth preset threshold.

Optionally, the fifth preset threshold is predefined, preconfigured, indicated by the network side, or preset.

Optionally, the sixth preset threshold is predefined, preconfigured, indicated by the network side, or preset.

Optionally, the seventh preset threshold is predefined, preconfigured, indicated by the network side, or preset.

Optionally, the eighth preset threshold is predefined, preconfigured, indicated by the network side, or preset.

Optionally, the ninth preset threshold is predefined, preconfigured, indicated by the network side, or preset.

Optionally, the change parameter may include at least one of the following:
a change beam parameter, a change TRP parameter, a change reference signal parameter, or the like.

Optionally, the low mobility includes at least one of the following:
1. the measurement performance change amount of the terminal is less than the fifth preset threshold, where
optionally, is less than the fifth preset threshold in preset time;
2. the difference between measurement performance and the reference quantity of the terminal is less than the sixth preset threshold, where
optionally, is less than the sixth preset threshold in the preset time;
3. the quantity of mobile cells (including cell selection and reselection or handover) of the terminal is less than the seventh preset threshold, where
optionally, is less than the seventh preset threshold in the preset time;
4. the quantity of times that the terminal changes the parameter such as a beam/TRP/Beam/RS is less than the eighth preset threshold, where
optionally, is less than the eighth preset threshold in the preset time; or
5. the terminal determines the low mobility based on a sensor or another moving speed determining module.

Optionally, the high mobility includes at least one of the following:
the measurement performance change amount is greater than or equal to the fifth preset threshold;
the difference between the measurement performance and the reference quantity is greater than or equal to the sixth preset threshold;
the quantity of mobile cells is greater than or equal to the seventh preset threshold;
the quantity of parameter change times is greater than or equal to the eighth preset threshold; or
the moving speed is greater than or equal to the ninth preset threshold.

Optionally, the high mobility includes at least one of the following:
1. the measurement performance change amount of the terminal is greater than the fifth preset threshold, where
optionally, is greater than the fifth preset threshold in preset time;
2. the difference between measurement performance and the reference quantity of the terminal is greater than the sixth preset threshold, where
optionally, is greater than the sixth preset threshold in the preset time;
3. the quantity of mobile cells (including cell selection and reselection or handover) of the terminal is greater than the seventh preset threshold, where
optionally, is greater than the seventh preset threshold in the preset time;
4. the quantity of times that the terminal changes the parameter such as a beam/TRP/Beam/RS is greater than the eighth preset threshold, where
optionally, is greater than the eighth preset threshold in the preset time; or
5. the terminal determines the high mobility based on a sensor or another moving speed determining module.

Optionally, the low mobility includes at least one of the following:
a measurement performance change amount in preset time is less than a fifth preset threshold;
a difference between measurement performance and a reference quantity in the preset time is less than a sixth preset threshold;
a quantity of mobile cells in the preset time is less than a seventh preset threshold; or
a quantity of parameter change times in the preset time is less than an eighth preset threshold.

Optionally, the high mobility includes at least one of the following:
the measurement performance change amount in the preset time is greater than or equal to the fifth preset threshold;
the difference between the measurement performance and the reference quantity in the preset time is greater than or equal to the sixth preset threshold;
the quantity of mobile cells in the preset time is greater than or equal to the seventh preset threshold; or
the quantity of parameter change times in the preset time is greater than or equal to the eighth preset threshold.

Optionally, the measurement performance includes at least one of the following: reference signal received power RSRP, reference signal received quality RSRQ, a signal-to-interference-plus-noise ratio SINR, a measurement level value, or a preset measurement quantity.

Optionally, the measurement performance includes at least one of the following:
1: the RSRP;
2: the RSRQ; or
3: the SINR.

Optionally, the measurement performance includes at least one of the following: measurement performance for measuring a reference signal, measurement performance for measuring the LP-WUS, or measurement performance for measuring a beacon signal.

The measurement performance includes at least one of the following:
1. the measurement performance for the reference signal;
2. the measurement performance for the LP-WUS reference signal; or
3. the measurement performance for the beacon signal.

Optionally, the reference signal (RS) includes: an SSB, a CSI-RS, a DMRS, and a preset reference signal. The preset reference signal is a newly defined reference signal other than the foregoing reference signal or a reference signal that may be used for measurement.

Optionally, the measurement of the LP-WUS reference signal includes: measurement of the LP-WUS; measurement of an LP-WUS part, for example, a preamble part, or a data part; or measurement of a reference signal corresponding to the LP-WUS, where the reference signal is used for synchronization or measurement purposes before receiving the LP-WUS.

Optionally, the measurement of the beacon signal include: measurement of the beacon signal; measurement of a beacon part, for example, a preamble part, or a data part; or measurement of a reference signal corresponding to the LP-WUS, where the reference signal is used for synchronization or measurement purposes before receiving the beacon signal.

Optionally, the beacon signal (beacon) may be a separate signal different from the low power wake-up signal LP-WUS, or may be a part of the LP-WUS. For example, in some embodiments, the LP-WUS includes a preamble part and a data part, and the beacon may be a preamble part of the LP-WUS.

Optionally, the measurement performance includes at least one of the following: measurement performance for measuring the main radio or the main radio module; or measurement performance for measuring a low power receiver or a low power receiving module.

Optionally, the measurement performance includes at least one of the following:
1. measurement performance of the main radio (Main receiver); or
2. measurement performance of the low power receiver (LP receiver).

Optionally, the measurement performance includes at least one of the following: the reference signal received power RSRP, the reference signal received quality RSRQ, the signal-to-interference-plus-noise ratio SINR, the measurement level value, the preset measurement quantity, the measurement performance for measuring the reference signal, the measurement performance for measuring the LP-WUS, the measurement performance for measuring the beacon signal, the measurement performance for measuring the main radio or the main radio module, or the measurement performance for measuring the low power receiver or the low power receiving module.

Optionally, that the terminal executes the first operation includes at least one of the following:
after eleventh preset time or in the eleventh preset time, executing the operation associated with the low power wake-up signal LP-WUS;
after twelfth preset time or in the twelfth preset time, turning on the main radio or the main radio module; or
after thirteenth preset time or in the thirteenth preset time, receiving the signal by the main radio or the main radio module.

Optionally, the eleventh preset time is eleventh preset time elapsed under the preset condition.

Optionally, the twelfth preset time is twelfth preset time elapsed under the preset condition.

Optionally, the thirteenth preset time is thirteenth preset time elapsed under the preset condition.

Optionally, after the eleventh preset time or in the eleventh preset time may mean after the eleventh preset time after the preset condition is satisfied, or in the eleventh preset time after the preset condition is satisfied.

Optionally, after the twelfth preset time or in the twelfth preset time may mean after the twelfth preset time after the preset condition is satisfied, or in the twelfth preset time after the preset condition is satisfied.

Optionally, after the thirteenth preset time or in the thirteenth preset time may mean after the thirteenth preset time after the preset condition is satisfied, or in the thirteenth preset time after the preset condition is satisfied.

Optionally, after the eleventh preset time or in the eleventh preset time may mean after the eleventh preset time after the first preset condition is satisfied, or in the eleventh preset time after the first preset condition is satisfied, or after the eleventh preset time after the second preset condition is not satisfied, or in the eleventh preset time after the second preset condition is not satisfied.

Optionally, after the twelfth preset time or in the twelfth preset time may mean after the twelfth preset time after the first preset condition is satisfied, or in the twelfth preset time after the first preset condition is satisfied, or after the twelfth preset time after the second preset condition is not satisfied, or in the twelfth preset time after the second preset condition is not satisfied.

Optionally, after the thirteenth preset time or in the thirteenth preset time may mean after the thirteenth preset time after the first preset condition is satisfied, or in the thirteenth preset time after the first preset condition is satisfied, or after the thirteenth preset time after the second preset condition is not satisfied, or in the thirteenth preset time after the second preset condition is not satisfied.

Optionally, the eleventh preset time, the twelfth preset time, and the thirteenth preset time are preset time under the preset condition.

Optionally, the eleventh preset time is predefined, preconfigured, indicated by the network side, or preset.

Optionally, the twelfth preset time is predefined, preconfigured, indicated by the network side, or preset.

Optionally, the thirteenth preset time is predefined, preconfigured, indicated by the network side, or preset.

Optionally, if the first preset condition is satisfied, or the second preset condition is not satisfied, the terminal executes at least one of the following operations:
1. skipping or ignoring the LP-WUS (Skip LP-WUS); and/or
skipping or ignoring LP-WUS (Skip LP-WUS) after the preset time;
2. turning off the LP-WUR receiver/receiving module; and/or
turning off the LP-WUR receiver/receiving module after the preset time;
3. deactivating or disabling the LP-WUS function (LP-WUS disable); and/or
deactivating or disabling the LP-WUS function (LP-WUS disable) after the preset time;
4. exiting the LP-sleep state; and/or
exiting the LP-sleep state after the preset time;
5. turning on the main radio/the main radio module (Main receiver); and/or
turning on the main radio/the main radio module (Main receiver) after the preset time;
6. monitoring the PDCCH by the main radio (Main receiver); and/or
monitoring the PDCCH by the main receiver after the preset time;
7. receiving the LP-WUS by the main receiver; and/or
receiving the LP-WUS by the main receiver after the preset time; or
8. the terminal reports first information to the network side; and/or
the terminal reports the first information to the network side after the preset time.

Optionally, in a case that the first preset condition is satisfied or the second preset condition is not satisfied, the first operation may be executed after the eleventh preset time.

Optionally, in a case that the first preset condition is satisfied or the second preset condition is not satisfied, the first operation is executed after the eleventh preset time; or in a case that the first preset condition is satisfied or the second preset condition is not satisfied, the first operation is executed in the eleventh preset time.

Optionally, in a case that the first preset condition is satisfied or the second preset condition is not satisfied, the first operation is executed after the twelfth preset time; or in a case that the first preset condition is satisfied or the second preset condition is not satisfied, the first operation is executed in the twelfth preset time.

Optionally, in a case that the first preset condition is satisfied or the second preset condition is not satisfied, the first operation is executed after the thirteenth preset time; or in a case that the first preset condition is satisfied or the second preset condition is not satisfied, the first operation is executed in the thirteenth preset time.

Optionally, that the operation associated with the low power wake-up signal LP-WUS is executed after the eleventh preset time or in the eleventh preset time may include: In a case that the first preset condition is satisfied or the second preset condition is not satisfied, the first operation is executed after the eleventh preset time.

Optionally, in a case that the first preset condition is satisfied or the second preset condition is not satisfied, the first operation may be executed after the twelfth preset time.

Optionally, that the main radio or the main radio module is turned on after the twelfth preset time or in the twelfth preset time may include: In a case that the first preset condition is satisfied or the second preset condition is not satisfied, the first operation is executed after the twelfth preset time.

Optionally, in a case that the first preset condition is satisfied or the second preset condition is not satisfied, the first operation may be executed after the thirteenth preset time.

Optionally, that the main radio or the main radio module receives the signal after the thirteenth preset time or in the thirteenth preset time may include: In a case that the first preset condition is satisfied or the second preset condition is not satisfied, the first operation is executed after the thirteenth preset time.

Optionally, the first operation further includes:
the terminal reports first information to the network side, where the first information is used to indicate at least one of the following:
the terminal satisfies the preset condition;
the terminal skips or ignores the low power wake-up signal;
the terminal requests to skip or ignore the low power wake-up signal;
the terminal turns off the low power wake-up receiver or the low power wake-up receiving module;
the terminal requests to turn off the low power wake-up receiver or the low power wake-up receiving module;
the terminal deactivates or turns off the low power receiver or the low power receiving module;
the terminal requests to deactivate or turn off the low power receiver or the low power receiving module;
the terminal deactivates or disables the low power wake-up function;
the terminal requests to deactivate or disable the low power wake-up function;
the terminal turns on the main radio or the main radio module;
the terminal requests to turn on the main radio or the main radio module;
the terminal monitors the physical downlink control channel by the main radio or the main radio module;
the terminal requests to monitor the physical downlink control channel by the main radio or the main radio module;
the terminal receives the low power wake-up signal by the main radio or the main radio module; or
the terminal requests to receive the low power wake-up signal by the main radio or the main radio module.

Optionally, the foregoing first information may indicate, to the network side, the terminal to execute the foregoing operation, or the foregoing operation is requested to be executed to the network side, so that a behavior of the terminal to the network side is consistent with that of the terminal, thereby avoiding a communication exception between the terminal and the network side.

Optionally, that the terminal executes the first operation includes:

Under the preset condition, after fourteenth preset time or a timer expires, the terminal executes the first operation, where
the fourteenth preset time is preset time after the terminal sends the first information to the network side, and the timer is a timer that is started after the terminal sends the first information to the network side.

Optionally, the fourteenth preset time is predefined, preconfigured, indicated by the network side, or preset.

Optionally, after the preset time or the timer after sending the first information expires, the foregoing operation may be executed, so that the terminal may be prepared in advance before executing the foregoing operation, to improve service performance of the terminal, for example, ensure that a communication delay is not affected. Optionally, after the preset time or the timer after sending the first information expires, for example, the first operation is executed, or at least one of the following is executed:
1. skipping or ignoring the LP-WUS (Skip LP-WUS);
2. turning off the LP-WUR receiver/receiving module;
3. deactivating or disabling the LP-WUS function (LP-WUS disable);
4. turning on the main receiver;
5. monitoring the PDCCH by the main receiver; or
6. receiving the LP-WUS by the main receiver.

Optionally, that the terminal executes the first operation under the preset condition includes:

In a case that the network side configures the terminal to monitor the LP-WUS, the terminal executes the first operation under the preset condition.

Optionally, in a case that the network side configures the terminal to monitor the LP-WUS, if the first preset condition is satisfied or the second preset condition is not satisfied, the terminal executes the first operation.

In this embodiment of this application, the terminal executes the first operation under the preset condition, where the first operation includes at least one of the following: the operation associated with the low power wake-up signal LP-WUS; turning on the main radio or the main radio module; or receiving the signal by the main radio or the main radio module. In this way, fallback to the normal state may be performed when the preset condition is satisfied; and the scenario in which the terminal uses the LP-WUS function is limited, so that fast and accurate fallback can be performed when it is ensured that the terminal saves power as much as possible, thereby effectively ensuring mobile performance of the terminal and delay performance of the service.

The communication operation execution method provided in the embodiments of this application may be performed by a communication operation execution apparatus. In the embodiments of this application, that the communication operation execution apparatus performs the communication operation execution method is used as an example, to describe the communication operation execution apparatus provided in the embodiments of this application.

FIG. 7 is a schematic flowchart of a communication operation execution apparatus according to an embodiment of this application. As shown in FIG. 7, the apparatus 700 includes:
an execution module 710, configured to execute a first operation under a preset condition, where the first operation includes at least one of the following:
an operation associated with a low power wake-up signal LP-WUS;
turning on a main radio or a main radio module; or
receiving a signal by the main radio or the main radio module.

In this embodiment of this application, a terminal executes the first operation under the preset condition, where the first operation includes at least one of the following: the operation associated with the low power wake-up signal LP-WUS; turning on the main radio or the main radio module; or receiving the signal by the main radio or the main radio module. In this way, fallback to a normal state may be performed when the preset condition is satisfied; and a scenario in which the terminal uses an LP-WUS function is limited, so that fast and accurate fallback can be performed when it is ensured that the terminal saves power as much as possible, thereby effectively ensuring mobile performance of the terminal and delay performance of the service.

Optionally, the operation associated with the low power wake-up signal LP-WUS includes at least one of the following:
skipping or ignoring the low power wake-up signal LP-WUS;
turning off a low power wake-up receiver or a low power wake-up receiving module LP-WUR;
deactivating or disabling a low power wake-up function; or
exiting a low power sleep state.

Optionally, the skipping or ignoring the low power wake-up signal LP-WUS includes: temporarily skipping or ignoring the low power wake-up signal LP-WUS.

Optionally, the temporarily skipping or ignoring the low power wake-up signal LP-WUS includes at least one of the following:
skipping or ignoring a current or next LP-WUS;
skipping or ignoring the low power wake-up signal LP-WUS, where a quantity of skipped or ignored LP-WUSs is a fifth preset quantity;
skipping or ignoring the low power wake-up signal LP-WUS, where duration of the skipped or ignored LP-WUS is a first preset quantity of periods;
skipping or ignoring the low power wake-up signal LP-WUS, where time for skipping or ignoring the LP-WUS is a first preset time period; or
skipping or ignoring the low power wake-up signal LP-WUS until monitoring of the LP-WUS is enabled, or until the low power wake-up function is enabled or activated, or until the LP-WUR is turned on.

Optionally, the skipping or ignoring the low power wake-up signal LP-WUS until monitoring of the LP-WUS is enabled, or until the low power wake-up function is enabled or activated, or until the LP-WUR is turned on includes at least one of the following:
skipping or ignoring the low power wake-up signal LP-WUS until a network side indicates the terminal to monitor the LP-WUS;
skipping or ignoring the low power wake-up signal LP-WUS until the network side indicates the terminal to enable or activate the low power wake-up function;
skipping or ignoring the low power wake-up signal LP-WUS until the network side indicates the terminal to turn on the LP-WUR;
skipping or ignoring the low power wake-up signal LP-WUS until monitoring of the LP-WUS is enabled, the low power wake-up function is enabled or activated, or a preset condition corresponding to the LP-WUR is enabled; or
skipping or ignoring the low power wake-up signal LP-WUS until the network side configures the LP-WUS or the LP-WUR.

Optionally, the turning off a low power wake-up receiver or a low power wake-up receiving module LP-WUR, or deactivating or disabling a low power wake-up function includes:
temporarily turning off the low power wake-up receiver or the low power wake-up receiving module LP-WUR, or temporarily deactivating or disabling the low power wake-up function.

Optionally, the temporarily turning off the low power wake-up receiver or the low power wake-up receiving module LP-WUR, or temporarily deactivating or disabling the low power wake-up function includes at least one of the following:
turning off the LP-WUR for a current or next LP-WUS;
turning off the LP-WUR, where duration of turning off the LP-WUR is a second preset quantity of periods;
turning off the LP-WUR, where duration of turning off the LP-WUR is a second preset time period;
turning off the LP-WUR until monitoring of the LP-WUS is enabled, or until the low power wake-up function is enabled or activated, or until the LP-WUR is turned on;
deactivating or disabling the low power wake-up function, where duration of deactivating or disabling the low power wake-up function is a second preset quantity of periods;
deactivating or disabling the low power wake-up function, where duration of deactivating or disabling the low power wake-up function is a second preset time period; or
deactivating or disabling the low power wake-up function until monitoring of the LP-WUS is enabled, or until the low power wake-up function is enabled or activated, or until the LP-WUR is turned on.

Optionally, the turning off the LP-WUR, or deactivating or disabling the low power wake-up function until monitoring of the LP-WUS is enabled, or until the low power wake-up function is enabled or activated, or until the LP-WUR is turned on includes at least one of the following:
turning off the LP-WUR, or deactivating or disabling the low power wake-up function until a network side indicates the terminal to monitor the LP-WUS;
turning off the LP-WUR, or deactivating or disabling the low power wake-up function until the network side indicates the terminal to enable or activate the low power wake-up function;
turning off the LP-WUR, or deactivating or disabling the low power wake-up function until the network side indicates the terminal to turn on the LP-WUR;
turning off the LP-WUR, or deactivating or disabling the low power wake-up function until monitoring of the LP-WUS is enabled, the low power wake-up function is enabled or activated, or a preset condition corresponding to the LP-WUR is enabled; or
turning off the LP-WUR, or deactivating or disabling the low power wake-up function until the network side configures the LP-WUS or the LP-WUR.

Optionally, the receiving the signal by the main radio or the main radio module includes:
monitoring a physical downlink control channel by the main radio or the main radio module; and
receiving the low power wake-up signal by the main radio or the main radio module.

Optionally, the preset condition includes at least one of the following:
satisfying a first preset condition or not satisfying the second preset condition, where the first preset condition includes a condition associated with at least one of the following:
cell measurement performance, a moving state, a receiving state, a terminal type, or a terminal capability; and/or
the second preset condition includes a condition associated with at least one of the following:
cell measurement performance, a moving state, a receiving state, a terminal type, or a terminal capability.

Optionally, the first preset condition includes at least one of the following:
measurement performance of a serving cell satisfies a first performance condition;
measurement performance of a neighboring cell satisfies a second performance condition;
the terminal is not in low mobility;
the terminal is in high mobility;
the terminal receives first indication information sent by the network side, where the first indication information is used to indicate a fallback operation;
the terminal type of the terminal is a normal terminal;
the terminal type of the terminal is not a low-capability terminal; or
the terminal has a first capability.

Optionally, that the measurement performance of the serving cell satisfies the first performance condition includes:
the measurement performance of the serving cell of the terminal is lower than or not higher than a first preset threshold; and/or
that the measurement performance of the neighboring cell satisfies the second performance condition includes:
the measurement performance of the serving cell of the terminal is higher than or not lower than a second preset threshold.

Optionally, that the measurement performance of the serving cell of the terminal is lower than or not higher than a first preset threshold includes at least one of the following:
the measurement performance of the serving cell in a third preset time period is lower than or not higher than the first preset threshold;
the measurement performance of the serving cell remains lower than or not higher than the first preset threshold for a fourth preset time period;
the measurement performance of the serving cell is lower than or not higher than the first preset threshold for a first preset quantity of times; or
the measurement performance of the serving cell in a measurement period of a first preset quantity is lower than or not higher than the first preset threshold.

Optionally, that the measurement performance of the neighboring cell of the terminal is higher than or not lower than a second preset threshold includes at least one of the following:
the measurement performance of the neighboring cell in a fifth preset time period is higher than or not lower than the second preset threshold;
the measurement performance of the neighboring cell remains higher than or not lower than the second preset threshold for a sixth preset time period;
the measurement performance of the neighboring cell is higher than or not lower than the second preset threshold for a second preset quantity of times; or
the measurement performance of the neighboring cell in a measurement period of a second preset quantity is higher than or not lower than the second preset threshold.

Optionally, the second preset condition includes:
measurement performance of a serving cell satisfies a third performance condition;
measurement performance of a neighboring cell satisfies a fourth performance condition;
the terminal is not in high mobility;
the terminal is in low mobility;
the terminal does not receive first indication information sent by the network side, where the first indication information is used to indicate a fallback operation;
the terminal type of the terminal is a low-capability terminal;
the terminal type of the terminal is not a normal terminal; and
the terminal has a second capability.

Optionally, that the measurement performance of the serving cell satisfies the third performance condition includes:
the measurement performance of the serving cell of the terminal is higher than or not lower than a third preset threshold; and/or
that the measurement performance of the neighboring cell satisfies the fourth performance condition includes:
the measurement performance of the neighboring cell of the terminal is lower than or not higher than a fourth preset threshold.

Optionally, that the measurement performance of the serving cell of the terminal is higher than or not lower than a third preset threshold includes:
the measurement performance of the serving cell in a seventh preset time period is higher than or not lower than the third preset threshold;
the measurement performance of the serving cell remains higher than or not lower than the third preset threshold for an eighth preset time period;
the measurement performance of the serving cell is higher than or not lower than the third preset threshold for a third preset quantity of times; and
the measurement performance of the serving cell in a measurement period of a third preset quantity is higher than or not lower than the third preset threshold.

Optionally, that the measurement performance of the neighboring cell of the terminal is lower than or not higher than a fourth preset threshold includes:
the measurement performance of the neighboring cell in a ninth preset time period is lower than or not higher than the fourth preset threshold;
the measurement performance of the neighboring cell remains lower than or not higher than the fourth preset threshold for a tenth preset time period;
the measurement performance of the neighboring cell is lower than or not higher than the fourth preset threshold for a fourth preset quantity of times; and
the measurement performance of the neighboring cell in a measurement period of a fourth preset quantity is lower than or not higher than the fourth preset threshold.

Optionally, the first capability includes at least one of the following:
supporting a capability of the low power wake-up receiver or the low power wake-up receiving module;
supporting a capability of the low power wake-up signal;
supporting a capability of a fallback mechanism in the low power sleep state;
supporting the capability of the fallback mechanism in the low power sleep state under the preset condition; or
supporting a capability of RRM measurement of a serving cell and/or neighboring cell during monitoring of the low power wake-up signal.

Optionally, the supporting a capability of a fallback mechanism in the low power sleep state includes at least one of the following:
supporting a capability of skipping or ignoring the low power wake-up signal;
supporting a capability of turning off the low power wake-up receiver or the low power wake-up receiving module;
supporting a capability of deactivating or disabling the low power wake-up function;
supporting a capability of turning on the main radio or the main radio module;
supporting a capability of monitoring the physical downlink control channel by the main radio or the main radio module; or
supporting a capability of receiving the low power wake-up signal by the main radio or the main radio module.

Optionally, the second capability includes at least one of the following:
in a case that the first preset condition is not satisfied, supporting a capability of the low power wake-up receiver or the low power wake-up receiving module; or
in a case that the first preset condition is not satisfied, supporting a capability of monitoring the low power wake-up signal.

Optionally, the first indication information is used to indicate at least one of the following:
skipping or ignoring the low power wake-up signal;
turning off the low power wake-up receiver or the low power wake-up receiving module;
deactivating or disabling the low power wake-up function;
turning on the main radio or the main radio module;
monitoring the physical downlink control channel by the main radio or the main radio module; or
receiving the low power wake-up signal by the main radio or the main radio module.

Optionally, the low mobility includes at least one of the following:
a measurement performance change amount is less than a fifth preset threshold;
a difference between measurement performance and a reference quantity is less than a sixth preset threshold;
a quantity of mobile cells is less than a seventh preset threshold;
a quantity of parameter change times is less than an eighth preset threshold; or
a moving speed is less than a ninth preset threshold.

Optionally, the high mobility includes at least one of the following:
the measurement performance change amount is greater than or equal to the fifth preset threshold;
the difference between the measurement performance and the reference quantity is greater than or equal to the sixth preset threshold;
the quantity of mobile cells is greater than or equal to the seventh preset threshold;
the quantity of parameter change times is greater than or equal to the eighth preset threshold; or
the moving speed is greater than or equal to the ninth preset threshold.

Optionally, the low mobility includes at least one of the following:
a measurement performance change amount in preset time is less than a fifth preset threshold;
a difference between measurement performance and a reference quantity in the preset time is less than a sixth preset threshold;
a quantity of mobile cells in the preset time is less than a seventh preset threshold; or
a quantity of parameter change times in the preset time is less than an eighth preset threshold.

Optionally, the high mobility includes at least one of the following:
the measurement performance change amount in the preset time is greater than or equal to the fifth preset threshold;
the difference between the measurement performance and the reference quantity in the preset time is greater than or equal to the sixth preset threshold;
the quantity of mobile cells in the preset time is greater than or equal to the seventh preset threshold; or
the quantity of parameter change times in the preset time is greater than or equal to the eighth preset threshold.

Optionally, the measurement performance includes at least one of the following: reference signal received power RSRP, reference signal received quality RSRQ, a signal-to-interference-plus-noise ratio SINR, a measurement level value, or a preset measurement quantity.

Optionally, the measurement performance includes at least one of the following: measurement performance for measuring a reference signal, measurement performance for measuring the LP-WUS, or measurement performance for measuring a beacon signal.

Optionally, the measurement performance includes at least one of the following: measurement performance for measuring the main radio or the main radio module; or measurement performance for measuring a low power receiver or a low power receiving module.

Optionally, the execution module 710 is configured to execute at least one of the following:
after eleventh preset time or in the eleventh preset time, executing the operation associated with the low power wake-up signal LP-WUS;
after twelfth preset time or in the twelfth preset time, turning on the main radio or the main radio module; or
after thirteenth preset time or in the thirteenth preset time, receiving the signal by the main radio or the main radio module.

Optionally, the first operation further includes:

The terminal reports first information to the network side, where the first information is used to indicate at least one of the following:
the terminal satisfies the preset condition;
the terminal skips or ignores the low power wake-up signal;
the terminal requests to skip or ignore the low power wake-up signal;
the terminal turns off the low power wake-up receiver or the low power wake-up receiving module;
the terminal requests to turn off the low power wake-up receiver or the low power wake-up receiving module;
the terminal deactivates or turns off the low power receiver or the low power receiving module;
the terminal requests to deactivate or turn off the low power receiver or the low power receiving module;
the terminal deactivates or disables the low power wake-up function;
the terminal requests to deactivate or disable the low power wake-up function;
the terminal turns on the main radio or the main radio module;
the terminal requests to turn on the main radio or the main radio module;
the terminal monitors the physical downlink control channel by the main radio or the main radio module;
the terminal requests to monitor the physical downlink control channel by the main radio or the main radio module;
the terminal receives the low power wake-up signal by the main radio or the main radio module; or the terminal requests to receive the low power wake-up signal by the main radio or the main radio module.

Optionally, the execution module 710 is configured to:
under the preset condition, after fourteenth preset time or a timer expires, execute the first operation, where
the fourteenth preset time is preset time after the terminal sends the first information to the network side, and the timer is a timer that is started after the terminal sends the first information to the network side.

Optionally, the execution module 710 is configured to:
in a case that the network side configures the terminal to monitor the LP-WUS, execute the first operation under the preset condition.

In this embodiment of this application, a terminal executes the first operation under the preset condition, where the first operation includes at least one of the following: the operation associated with the low power wake-up signal LP-WUS; turning on the main radio or the main radio module; or receiving the signal by the main radio or the main radio module. In this way, fallback to the normal state may be performed when the preset condition is satisfied; and the scenario in which the terminal uses the LP-WUS function is limited, so that fast and accurate fallback can be performed when it is ensured that the terminal saves power as much as possible, thereby effectively ensuring mobile performance of the terminal and delay performance of the service.

The communication operation execution apparatus in this embodiment of this application may be an electronic device, for example, an electronic device with an operating system, or may be a component in the electronic device, for example, an integrated circuit or a chip. The electronic device may be a terminal, or another device that is not the terminal. For example, the terminal may include but is not limited to the foregoing listed types of the terminal 11, and the another device may be a server, a network attached storage (NAS), or the like. This is not specifically limited in this embodiment of this application.

The communication operation execution apparatus provided in this embodiment of this application can implement the processes implemented in the method embodiment of FIG. 6, and same technical effect is achieved. To avoid repetition, details are not described herein again.

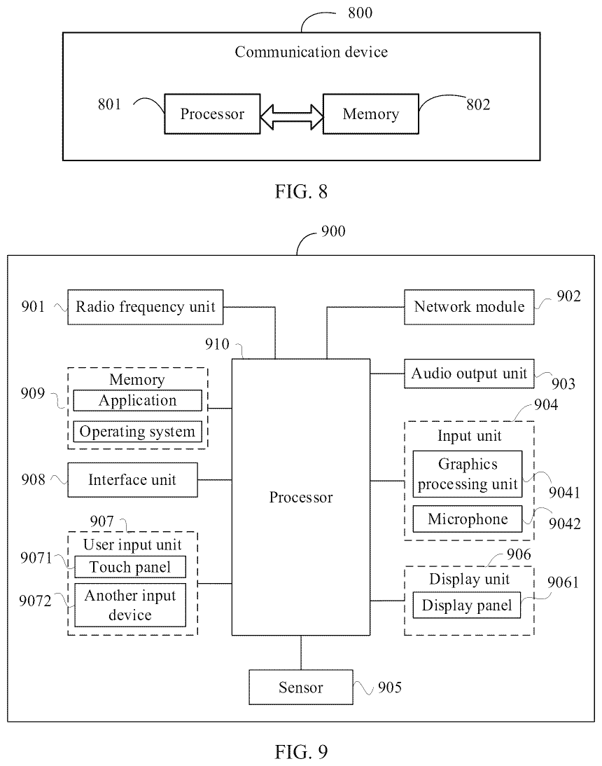

Optionally, FIG. 8 is a schematic diagram of a structure of a communication device according to an embodiment of this application. As shown in FIG. 8, an embodiment of this application further provides a communication device 800. The communication device 800 includes a processor 801 and a memory 802. The memory 802 stores a program or an instruction that is executable on the processor 801. For example, when the communication device 800 is a terminal, and the program or the instruction is executed by the processor 801, the steps of the foregoing communication operation execution method embodiment are implemented, and same technical effect can be achieved. When the communication device 800 is a network side device, and the program or the instruction is executed by the processor 801, the steps of the foregoing communication operation execution method embodiment are implemented, and same technical effect can be achieved. To avoid repetition, details are not described herein again.

An embodiment of this application further provides a terminal. The terminal includes a processor and a communication interface. The processor is configured to:
execute a first operation under a preset condition, where the first operation includes at least one of the following:
an operation associated with a low power wake-up signal LP-WUS;
turning on a main radio or a main radio module; or
receiving a signal by the main radio or the main radio module.

The terminal embodiment corresponds to the method embodiment on the terminal side, each implementation process and implementation of the method embodiment can be applied to the terminal embodiment, and same technical effect can be achieved. Optionally, FIG. 9 is a schematic diagram of a hardware structure of a terminal according to an embodiment of this application.

The terminal 900 includes but is not limited to at least a part of components such as a radio frequency unit 901, a network module 902, an audio output unit 903, an input unit 904, a sensor 905, a display unit 906, a user input unit 907, an interface unit 908, a memory 909, and a processor 910.

A person skilled in the art can understand that the terminal 900 may further include a power supply (such as a battery) that supplies power to each component. The power supply may be logically connected to the processor 910 by using a power supply management system, to implement functions such as charging and discharging management, and power consumption management by using the power supply management system. The terminal structure shown in FIG. 9 constitutes no limitation on the terminal, and the terminal may include more or fewer components than those shown in the figure, or combine some components, or have different component arrangements. Details are not described herein.

It should be understood that in this embodiment of this application, the input unit 904 may include a graphics processing unit (GPU) 9041 and a microphone 9042. The graphics processing unit 9041 processes image data of a static picture or a video obtained by an image capture apparatus (for example, a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 or another input device 9072. The touch panel 9071 is also referred to as a touchscreen. The touch panel 9071 may include two parts: a touch detection apparatus and a touch controller. The another input device 9072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 901 may transmit the downlink data to the processor 910 for processing. In addition, the radio frequency unit 901 may send uplink data to the network side device. Usually, the radio frequency unit 901 includes but is not limited to an antenna, an amplifier, a transceiver, a coupler, a low noise amplifier, a duplexer, and the like.

The memory 909 may be configured to store a software program or an instruction and various data. The memory 909 may mainly include a first storage area for storing a program or an instruction and a second storage area for storing data. The first storage area may store an operating system, and an application or an instruction required by at least one function (for example, a sound playing function or an image playing function). In addition, the memory 909 may be a volatile memory or a non-volatile memory, or the memory 909 may include a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 909 in this embodiment of this application includes but is not limited to these memories and any memory of another proper type.

The processor 910 may include one or more processing units. Optionally, an application processor and a modem processor are integrated into the processor 910. The application processor mainly processes an operating system, a user interface, an application, or the like. The modem processor mainly processes a wireless communication signal, for example, a baseband processor. It may be understood that, alternatively, the modem processor may not be integrated into the processor 910.

The processor 910 is configured to:
execute a first operation under a preset condition, where the first operation includes at least one of the following:
an operation associated with a low power wake-up signal LP-WUS;
turning on a main radio or a main radio module; or
receiving a signal by the main radio or the main radio module.

In this embodiment of this application, a terminal executes the first operation under the preset condition, where the first operation includes at least one of the following: the operation associated with the low power wake-up signal LP-WUS; turning on the main radio or the main radio module; or receiving the signal by the main radio or the main radio module. In this way, fallback to a normal state may be performed when the preset condition is satisfied; and a scenario in which the terminal uses an LP-WUS function is limited, so that fast and accurate fallback can be performed when it is ensured that the terminal saves power as much as possible, thereby effectively ensuring mobile performance of the terminal and delay performance of the service.

Optionally, the operation associated with the low power wake-up signal LP-WUS includes at least one of the following:
skipping or ignoring the low power wake-up signal LP-WUS;
turning off a low power wake-up receiver or a low power wake-up receiving module LP-WUR;
deactivating or disabling a low power wake-up function; or
exiting a low power sleep state.

Optionally, the skipping or ignoring the low power wake-up signal LP-WUS includes: temporarily skipping or ignoring the low power wake-up signal LP-WUS.

Optionally, the temporarily skipping or ignoring the low power wake-up signal LP-WUS includes at least one of the following:
skipping or ignoring a current or next LP-WUS;
skipping or ignoring the low power wake-up signal LP-WUS, where a quantity of
skipped or ignored LP-WUSs is a fifth preset quantity;
skipping or ignoring the low power wake-up signal LP-WUS, where duration of the skipped or ignored LP-WUS is a first preset quantity of periods;
skipping or ignoring the low power wake-up signal LP-WUS, where time for skipping or ignoring the LP-WUS is a first preset time period; or
skipping or ignoring the low power wake-up signal LP-WUS until monitoring of the LP-WUS is enabled, or until the low power wake-up function is enabled or activated, or until the LP-WUR is turned on.

Optionally, the skipping or ignoring the low power wake-up signal LP-WUS until monitoring of the LP-WUS is enabled, or until the low power wake-up function is enabled or activated, or until the LP-WUR is turned on includes at least one of the following:
skipping or ignoring the low power wake-up signal LP-WUS until a network side indicates the terminal to monitor the LP-WUS;
skipping or ignoring the low power wake-up signal LP-WUS until the network side indicates the terminal to enable or activate the low power wake-up function;
skipping or ignoring the low power wake-up signal LP-WUS until the network side indicates the terminal to turn on the LP-WUR;
skipping or ignoring the low power wake-up signal LP-WUS until monitoring of the LP-WUS is enabled, the low power wake-up function is enabled or activated, or a preset condition corresponding to the LP-WUR is enabled; or
skipping or ignoring the low power wake-up signal LP-WUS until the network side configures the LP-WUS or the LP-WUR.

Optionally, the turning off a low power wake-up receiver or a low power wake-up receiving module LP-WUR, or deactivating or disabling a low power wake-up function includes:
temporarily turning off the low power wake-up receiver or the low power wake-up receiving module LP-WUR, or temporarily deactivating or disabling the low power wake-up function.

Optionally, the temporarily turning off the low power wake-up receiver or the low power wake-up receiving module LP-WUR, or temporarily deactivating or disabling the low power wake-up function includes at least one of the following:
turning off the LP-WUR for a current or next LP-WUS;
turning off the LP-WUR, where duration of turning off the LP-WUR is a second preset quantity of periods;
turning off the LP-WUR, where duration of turning off the LP-WUR is a second preset time period;
turning off the LP-WUR until monitoring of the LP-WUS is enabled, or until the low power wake-up function is enabled or activated, or until the LP-WUR is turned on;
deactivating or disabling the low power wake-up function, where duration of deactivating or disabling the low power wake-up function is a second preset quantity of periods;
deactivating or disabling the low power wake-up function, where duration of deactivating or disabling the low power wake-up function is a second preset time period; or
deactivating or disabling the low power wake-up function until monitoring of the LP-WUS is enabled, or until the low power wake-up function is enabled or activated, or until the LP-WUR is turned on.

Optionally, the turning off the LP-WUR, or deactivating or disabling the low power wake-up function until monitoring of the LP-WUS is enabled, or until the low power wake-up function is enabled or activated, or until the LP-WUR is turned on includes at least one of the following:
turning off the LP-WUR, or deactivating or disabling the low power wake-up function until a network side indicates the terminal to monitor the LP-WUS;
turning off the LP-WUR, or deactivating or disabling the low power wake-up function until the network side indicates the terminal to enable or activate the low power wake-up function;
turning off the LP-WUR, or deactivating or disabling the low power wake-up function until the network side indicates the terminal to turn on the LP-WUR;
turning off the LP-WUR, or deactivating or disabling the low power wake-up function until monitoring of the LP-WUS is enabled, the low power wake-up function is enabled or activated, or a preset condition corresponding to the LP-WUR is enabled; or
turning off the LP-WUR, or deactivating or disabling the low power wake-up function until the network side configures the LP-WUS or the LP-WUR.

Optionally, the receiving the signal by the main radio or the main radio module includes:
monitoring a physical downlink control channel by the main radio or the main radio module; and
receiving the low power wake-up signal by the main radio or the main radio module.

Optionally, the preset condition includes at least one of the following:
satisfying a first preset condition or not satisfying the second preset condition, where the first preset condition includes a condition associated with at least one of the following:
cell measurement performance, a moving state, a receiving state, a terminal type, or a terminal capability; and/or
the second preset condition includes a condition associated with at least one of the following:
cell measurement performance, a moving state, a receiving state, a terminal type, or a terminal capability.

Optionally, the first preset condition includes at least one of the following:
measurement performance of a serving cell satisfies a first performance condition;
measurement performance of a neighboring cell satisfies a second performance condition;
the terminal is not in low mobility;
the terminal is in high mobility;
the terminal receives first indication information sent by the network side, where the first indication information is used to indicate a fallback operation;
the terminal type of the terminal is a normal terminal;
the terminal type of the terminal is not a low-capability terminal; or
the terminal has a first capability.

Optionally, that the measurement performance of the serving cell satisfies the first performance condition includes:
the measurement performance of the serving cell of the terminal is lower than or not higher than a first preset threshold; and/or
that the measurement performance of the neighboring cell satisfies the second performance condition includes: t
he measurement performance of the serving cell of the terminal is higher than or not lower than a second preset threshold.

Optionally, that the measurement performance of the serving cell of the terminal is lower than or not higher than a first preset threshold includes at least one of the following:
the measurement performance of the serving cell in a third preset time period is lower than or not higher than the first preset threshold;
the measurement performance of the serving cell remains lower than or not higher than the first preset threshold for a fourth preset time period;
the measurement performance of the serving cell is lower than or not higher than the first preset threshold for a first preset quantity of times; or
the measurement performance of the serving cell in a measurement period of a first preset quantity is lower than or not higher than the first preset threshold.

Optionally, that the measurement performance of the neighboring cell of the terminal is higher than or not lower than a second preset threshold includes at least one of the following:
the measurement performance of the neighboring cell in a fifth preset time period is higher than or not lower than the second preset threshold;
the measurement performance of the neighboring cell remains higher than or not lower than the second preset threshold for a sixth preset time period;
the measurement performance of the neighboring cell is higher than or not lower than the second preset threshold for a second preset quantity of times; or
the measurement performance of the neighboring cell in a measurement period of a second preset quantity is higher than or not lower than the second preset threshold.

Optionally, the second preset condition includes:
measurement performance of a serving cell satisfies a third performance condition;
measurement performance of a neighboring cell satisfies a fourth performance condition;
the terminal is not in high mobility;
the terminal is in low mobility;
the terminal does not receive first indication information sent by the network side, where the first indication information is used to indicate a fallback operation;
the terminal type of the terminal is a low-capability terminal;
the terminal type of the terminal is not a normal terminal; and
the terminal has a second capability.

Optionally, that the measurement performance of the serving cell satisfies the third performance condition includes:
the measurement performance of the serving cell of the terminal is higher than or not lower than a third preset threshold; and/or
that the measurement performance of the neighboring cell satisfies the fourth performance condition includes:
the measurement performance of the neighboring cell of the terminal is lower than or not higher than a fourth preset threshold.

Optionally, that the measurement performance of the serving cell of the terminal is higher than or not lower than a third preset threshold includes:
the measurement performance of the serving cell in a seventh preset time period is higher than or not lower than the third preset threshold;
the measurement performance of the serving cell remains higher than or not lower than the third preset threshold for an eighth preset time period;
the measurement performance of the serving cell is higher than or not lower than the third preset threshold for a third preset quantity of times; and
the measurement performance of the serving cell in a measurement period of a third preset quantity is higher than or not lower than the third preset threshold.

Optionally, that the measurement performance of the neighboring cell of the terminal is lower than or not higher than a fourth preset threshold includes:
the measurement performance of the neighboring cell in a ninth preset time period is lower than or not higher than the fourth preset threshold;
the measurement performance of the neighboring cell remains lower than or not higher than the fourth preset threshold for a tenth preset time period;
the measurement performance of the neighboring cell is lower than or not higher than the fourth preset threshold for a fourth preset quantity of times; and
the measurement performance of the neighboring cell in a measurement period of a fourth preset quantity is lower than or not higher than the fourth preset threshold.

Optionally, the first capability includes at least one of the following:
supporting a capability of the low power wake-up receiver or the low power wake-up
receiving module;
supporting a capability of the low power wake-up signal; supporting a capability of a fallback mechanism in the low power sleep state;
supporting the capability of the fallback mechanism in the low power sleep state under the preset condition; or
supporting a capability of RRM measurement of a serving cell and/or neighboring cell during monitoring of the low power wake-up signal.

Optionally, the supporting a capability of a fallback mechanism in the low power sleep state includes at least one of the following:
supporting a capability of skipping or ignoring the low power wake-up signal;
supporting a capability of turning off the low power wake-up receiver or the low power wake-up receiving module;
supporting a capability of deactivating or disabling the low power wake-up function; supporting a capability of turning on the main radio or the main radio module;
supporting a capability of monitoring the physical downlink control channel by the main radio or the main radio module; or
supporting a capability of receiving the low power wake-up signal by the main radio or the main radio module.

Optionally, the second capability includes at least one of the following:
in a case that the first preset condition is not satisfied, supporting a capability of the low power wake-up receiver or the low power wake-up receiving module; or
in a case that the first preset condition is not satisfied, supporting a capability of monitoring the low power wake-up signal.

Optionally, the first indication information is used to indicate at least one of the following:
skipping or ignoring the low power wake-up signal;
turning off the low power wake-up receiver or the low power wake-up receiving module;
deactivating or disabling the low power wake-up function;
turning on the main radio or the main radio module;
monitoring the physical downlink control channel by the main radio or the main radio module; or
receiving the low power wake-up signal by the main radio or the main radio module.

Optionally, the low mobility includes at least one of the following:
a measurement performance change amount is less than a fifth preset threshold;
a difference between measurement performance and a reference quantity is less than a sixth preset threshold;
a quantity of mobile cells is less than a seventh preset threshold;
a quantity of parameter change times is less than an eighth preset threshold; or
a moving speed is less than a ninth preset threshold.

Optionally, the high mobility includes at least one of the following:
the measurement performance change amount is greater than or equal to the fifth preset threshold;
the difference between the measurement performance and the reference quantity is greater than or equal to the sixth preset threshold;
the quantity of mobile cells is greater than or equal to the seventh preset threshold;
the quantity of parameter change times is greater than or equal to the eighth preset threshold; or
the moving speed is greater than or equal to the ninth preset threshold.

Optionally, the low mobility includes at least one of the following:
a measurement performance change amount in preset time is less than a fifth preset threshold;
a difference between measurement performance and a reference quantity in the preset time is less than a sixth preset threshold;
a quantity of mobile cells in the preset time is less than a seventh preset threshold; or
a quantity of parameter change times in the preset time is less than an eighth preset threshold.

Optionally, the high mobility includes at least one of the following:
the measurement performance change amount in the preset time is greater than or equal to the fifth preset threshold;
the difference between the measurement performance and the reference quantity in the preset time is greater than or equal to the sixth preset threshold;
the quantity of mobile cells in the preset time is greater than or equal to the seventh preset threshold; or
the quantity of parameter change times in the preset time is greater than or equal to the eighth preset threshold.

Optionally, the measurement performance includes at least one of the following: reference signal received power RSRP, reference signal received quality RSRQ, a signal-to-interference-plus-noise ratio SINR, a measurement level value, or a preset measurement quantity.

Optionally, the measurement performance includes at least one of the following: measurement performance for measuring a reference signal, measurement performance for measuring the LP-WUS, or measurement performance for measuring a beacon signal.

Optionally, the measurement performance includes at least one of the following: measurement performance for measuring the main radio or the main radio module; or measurement performance for measuring a low power receiver or a low power receiving module.

Optionally, the processor 910 is configured to perform at least one of the following:
after eleventh preset time or in the eleventh preset time, executing the operation associated with the low power wake-up signal LP-WUS;
after twelfth preset time or in the twelfth preset time, turning on the main radio or the main radio module; or
after thirteenth preset time or in the thirteenth preset time, receiving the signal by the main radio or the main radio module.

Optionally, the first operation further includes:
reporting, by the terminal, first information to the network side, where the first information is used to indicate at least one of the following:
the terminal satisfies the preset condition;
the terminal skips or ignores the low power wake-up signal;
the terminal requests to skip or ignore the low power wake-up signal;
the terminal turns off the low power wake-up receiver or the low power wake-up receiving module;
the terminal requests to turn off the low power wake-up receiver or the low power wake-up receiving module;
the terminal deactivates or turns off the low power receiver or the low power receiving module;
the terminal requests to deactivate or turn off the low power receiver or the low power receiving module;
the terminal deactivates or disables the low power wake-up function;
the terminal requests to deactivate or disable the low power wake-up function;
the terminal turns on the main radio or the main radio module;
the terminal requests to turn on the main radio or the main radio module;
the terminal monitors the physical downlink control channel by the main radio or the main radio module;
the terminal requests to monitor the physical downlink control channel by the main radio or the main radio module;
the terminal receives the low power wake-up signal by the main radio or the main radio module; or
the terminal requests to receive the low power wake-up signal by the main radio or the main radio module.

Optionally, the processor 910 is configured to:
under the preset condition, after fourteenth preset time or a timer expires, performing, by the terminal, the first operation, where
the fourteenth preset time is preset time after the terminal sends the first information to the network side, and the timer is a timer that is started after the terminal sends the first information to the network side.

Optionally, the processor 910 is configured to:
in a case in which the network side configures the terminal to monitor the LP-WUS, executing, by the terminal, the first operation under the preset condition.

In this embodiment of this application, a terminal executes the first operation under the preset condition, where the first operation includes at least one of the following: the operation associated with the low power wake-up signal LP-WUS; turning on the main radio or the main radio module; or receiving the signal by the main radio or the main radio module. In this way, fallback to the normal state may be performed when the preset condition is satisfied; and the scenario in which the terminal uses the LP-WUS function is limited, so that fast and accurate fallback can be performed when it is ensured that the terminal saves power as much as possible, thereby effectively ensuring mobile performance of the terminal and delay performance of the service.

An embodiment of this application further provides a non-transitory readable storage medium. The non-transitory readable storage medium stores a program or an instruction; and when the program or the instruction is executed by a processor, the processes of the foregoing communication operation execution method embodiment are implemented, and same technical effect can be achieved. To avoid repetition, details are not described herein again.

The processor is a processor in the terminal in the foregoing embodiments. The non-transitory readable storage medium includes a non-transitory computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, the processor is configured to execute a program or an instruction, to implement the processes of the foregoing communication operation execution method embodiment, and same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, the computer program/program product is executed by at least one processor, to implement the processes of the foregoing communication operation execution method embodiment, and same technical effect can be achieved. To avoid repetition, details are not described herein again.

An embodiment of this application further provides a communication operation execution system. The system includes: a terminal. The terminal may be configured to perform the steps of the foregoing communication operation execution method.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. A communication operation execution method, comprising:
executing, by a terminal, a first operation under a preset condition, wherein the first operation comprises at least one of the following:
an operation associated with a low power wake-up signal (LP-WUS);
turning on a main radio or a main radio module; or
receiving a signal by the main radio or the main radio module.

2. The communication operation execution method according to claim 1, wherein the operation associated with the LP-WUS comprises at least one of the following:
skipping or ignoring the LP-WUS;
turning off a low power wake-up receiver or a low power wake-up receiving module;
deactivating or disabling a low power wake-up function; or
exiting a low power sleep state.

3. The communication operation execution method according to claim 1, wherein the receiving a signal by the main radio or the main radio module comprises:
monitoring a physical downlink control channel by the main radio or the main radio module; and
receiving the LP-WUS by the main radio or the main radio module.

4. The communication operation execution method according to claim 1, wherein the preset condition comprises at least one of the following:
satisfying a first preset condition or not satisfying the second preset condition, wherein
the first preset condition comprises a condition associated with at least one of the following:
cell measurement performance, a moving state, a receiving state, a terminal type, or a terminal capability; and/or
the second preset condition comprises a condition associated with at least one of the following:
cell measurement performance, a moving state, a receiving state, a terminal type, or a terminal capability.

5. The communication operation execution method according to claim 4, wherein the first preset condition comprises at least one of the following:
measurement performance of a serving cell satisfies a first performance condition;
measurement performance of a neighboring cell satisfies a second performance condition;
the terminal is not in low mobility;
the terminal is in high mobility;
the terminal receives first indication information sent by the network side, wherein the first indication information is used to indicate a fallback operation;
the terminal type of the terminal is a normal terminal;
the terminal type of the terminal is not a low-capability terminal; or
the terminal has a first capability.

6. The communication operation execution method according to claim 5, wherein that measurement performance of a serving cell satisfies a first performance condition comprises:
the measurement performance of the serving cell of the terminal is lower than or not higher than a first preset threshold; and/or
that the measurement performance of the neighboring cell satisfies the second performance condition comprises:
the measurement performance of the neighboring cell of the terminal is higher than or not lower than a second preset threshold.

7. The communication operation execution method according to claim 4, wherein the second preset condition comprises:
measurement performance of a serving cell satisfies a third performance condition;
measurement performance of a neighboring cell satisfies a fourth performance condition;
the terminal is not in high mobility;
the terminal is in low mobility;
the terminal does not receive first indication information sent by the network side, wherein the first indication information is used to indicate a fallback operation;
the terminal type of the terminal is a low-capability terminal;
the terminal type of the terminal is not a normal terminal; or
the terminal has a second capability.

8. A terminal, comprising a processor and a memory, wherein the memory stores a program or an instruction that is executable on the processor; and the program or the instruction, when executed by the processor, causes the terminal to:
execute a first operation under a preset condition, wherein the first operation comprises at least one of the following:
an operation associated with a low power wake-up signal (LP-WUS);
turning on a main radio or a main radio module; or
receiving a signal by the main radio or the main radio module.

9. The terminal according to claim 8, wherein the operation associated with the LP-WUS comprises at least one of the following:
skipping or ignoring the LP-WUS;
turning off a low power wake-up receiver or a low power wake-up receiving module;
deactivating or disabling a low power wake-up function; or
exiting a low power sleep state.

10. The terminal according to claim 8, wherein the receiving a signal by the main radio or the main radio module comprises:
monitoring a physical downlink control channel by the main radio or the main radio module; and
receiving the LP-WUS by the main radio or the main radio module.

11. The terminal according to claim 8, wherein the preset condition comprises at least one of the following:
satisfying a first preset condition or not satisfying the second preset condition, wherein the first preset condition comprises a condition associated with at least one of the following:
cell measurement performance, a moving state, a receiving state, a terminal type, or a terminal capability; and/or
the second preset condition comprises a condition associated with at least one of the following:
cell measurement performance, a moving state, a receiving state, a terminal type, or a terminal capability.

12. The terminal according to claim 11, wherein the first preset condition comprises at least one of the following:
measurement performance of a serving cell satisfies a first performance condition;
measurement performance of a neighboring cell satisfies a second performance condition;
the terminal is not in low mobility;
the terminal is in high mobility;
the terminal receives first indication information sent by the network side, wherein the first indication information is used to indicate a fallback operation;
the terminal type of the terminal is a normal terminal;
the terminal type of the terminal is not a low-capability terminal; or
the terminal has a first capability.

13. The terminal according to claim 12, wherein that measurement performance of a serving cell satisfies a first performance condition comprises:
the measurement performance of the serving cell of the terminal is lower than or not higher than a first preset threshold; and/or
that the measurement performance of the neighboring cell satisfies the second performance condition comprises:
the measurement performance of the neighboring cell of the terminal is higher than or not lower than a second preset threshold.

14. The terminal according to claim 11, wherein the second preset condition comprises:
measurement performance of a serving cell satisfies a third performance condition;
measurement performance of a neighboring cell satisfies a fourth performance condition;
the terminal is not in high mobility;
the terminal is in low mobility;
the terminal does not receive first indication information sent by the network side, wherein the first indication information is used to indicate a fallback operation;
the terminal type of the terminal is a low-capability terminal;
the terminal type of the terminal is not a normal terminal; or
the terminal has a second capability.

15. A non-transitory readable storage medium, wherein the non-transitory readable storage medium stores a program or an instruction; and the program or the instruction, when executed by a processor of a terminal, causes the terminal to:
execute, a first operation under a preset condition, wherein the first operation comprises at least one of the following:
an operation associated with a low power wake-up signal (LP-WUS);
turning on a main radio or a main radio module; or
receiving a signal by the main radio or the main radio module.

16. The non-transitory readable storage medium according to claim 15, wherein the operation associated with the LP-WUS comprises at least one of the following:
skipping or ignoring the LP-WUS;
turning off a low power wake-up receiver or a low power wake-up receiving module;
deactivating or disabling a low power wake-up function; or
exiting a low power sleep state.

17. The non-transitory readable storage medium according to claim 15, wherein the receiving a signal by the main radio or the main radio module comprises:
monitoring a physical downlink control channel by the main radio or the main radio module; and
receiving the LP-WUS by the main radio or the main radio module.

18. The non-transitory readable storage medium according to claim 15, wherein the preset condition comprises at least one of the following:
satisfying a first preset condition or not satisfying the second preset condition, wherein the first preset condition comprises a condition associated with at least one of the following:
cell measurement performance, a moving state, a receiving state, a terminal type, or a terminal capability; and/or
the second preset condition comprises a condition associated with at least one of the following:
cell measurement performance, a moving state, a receiving state, a terminal type, or a terminal capability.

19. The non-transitory readable storage medium according to claim 18, wherein the first preset condition comprises at least one of the following:
measurement performance of a serving cell satisfies a first performance condition;
measurement performance of a neighboring cell satisfies a second performance condition;
the terminal is not in low mobility;
the terminal is in high mobility;
the terminal receives first indication information sent by the network side, wherein the first indication information is used to indicate a fallback operation;
the terminal type of the terminal is a normal terminal;
the terminal type of the terminal is not a low-capability terminal; or
the terminal has a first capability.

20. The non-transitory readable storage medium according to claim 19, wherein that measurement performance of a serving cell satisfies a first performance condition comprises:
the measurement performance of the serving cell of the terminal is lower than or not higher than a first preset threshold; and/or
that the measurement performance of the neighboring cell satisfies the second performance condition comprises:
the measurement performance of the neighboring cell of the terminal is higher than or not lower than a second preset threshold.
